(19) United States
(12) Patent Application Publication
(10) Pub. No.: US 2026/0261604 A1
(43) Pub. Date: Sep. 3, 2026

(54) VEHICULAR SYSTEM, DATA COMMUNICATION SYSTEM, PROCESS-TARGET SPECIFYING PROGRAM, PROCESSTARGET SPECIFYING METHOD, VEHICLE- EXTERNAL DEVICE, SPECIFIER INFORMATION DELIVERY PROGRAM, AND SPECIFIER INFORMATION DELIVERY METHOD

(71) Applicant: DENSO CORPORATION, Kariya-city (JP)

(72) Inventors: Yuzo HARATA, Kaiya-city (JP); Kazuhiro Uehara, Kariya-city (JP); Yukiyasu Yoshimura, Kariya-City (JP)

(21) Appl. No.: 19/660,492

(22) Filed: Apr. 28, 2026

Related U.S. Application Data
(63) Continuation of application No. PCT/JP2024/034180, filed on Sep. 25, 2024.

(30) Foreign Application Priority Data
Oct. 30, 2023 (JP) 2023-185581

(51) Int. Cl. H04L 69/08; G06F 8/65; G07C 5/00; H04W 4/40

(52) U.S. Cl. CPC H04L 69/08; G06F 8/65; G07C 5/008; H04W 4/40

(57) ABSTRACT

A vehicular system acquires a message or a file in an SOVD format compliant with SOVD communication specifications. The vehicle system includes a storage that retains process-target specifier information indicating association between a process-command based on the message or the file in the SOVD format and connection destination information enabling to specify a process-target corresponding to the process-command. When the process-command is accepted, the vehicle system refers to the process-target specifier information and specifies the process-target corresponding to the accepted process-command based on the connection destination information.

### CROSS-REFERENCE TO RELATED APPLICATIONS

This application is a continuation application of International Patent Application No. PCT/JP 2024/034180 filed on Sep. 25, 2024, which designated the U.S. and claims the benefit of priority from Japanese Patent Application No. 2023-185581 filed on Oct. 30, 2023. The entire disclosures of all of the above applications are incorporated herein by reference.

### TECHNICAL FIELD

The present disclosure relates to a vehicular system, a data communication system, a process-target specifying program, a process-target specifying method, a vehicle-external device, a specifier information delivery program, and a specifier information delivery method.

### BACKGROUND

With the introduction of HPC (High-Performance Computer), a SOVD (Service-Oriented Vehicle Diagnostics) technology is provided as a next-generation diagnostic function for a vehicle.

### SUMMARY

According to an aspect of the present disclosure, a vehicular system acquires a message or a file in an SOVD format compliant with SOVD communication specifications. The vehicle system may include a storage that retains process-target specifier information indicating association between a process-command based on the message or the file in the SOVD format and connection destination information enabling to specify a process-target corresponding to the process-command. When the process-command is accepted, the vehicle system may refer to the process-target specifier information and specify the process-target corresponding to the accepted process-command based on the connection destination information.

### BRIEF DESCRIPTION OF DRAWINGS

Objects, features and advantages of the present disclosure will become more apparent from the following detailed description made with reference to the accompanying drawings. In the drawings:

FIG. 1 is a drawing showing an overall structure of a first embodiment;

FIG. 2 is a functional block diagram of an update master;

FIG. 3 is a diagram illustrating format conversion;

FIG. 4 is a diagram showing HTTP methods used in an SOVD format;

FIG. 5 is a diagram illustrating format conversion from an SOVD format to a UDS format;

FIG. 6 is a diagram illustrating format forming;

FIG. 7 is a flowchart showing OTA center processes at downloading;

FIG. 8 is a flowchart showing CGW processes at downloading;

FIG. 9 is a flowchart showing OTA center processes at uploading;

FIG. 10 is a flowchart showing CGW processes at uploading;

FIG. 11 is a diagram showing an overall structure of a second embodiment;

FIG. 12 is a functional block diagram of a process-target specifier table manager unit;

FIG. 13 is a diagram showing a process-target specifier table;

FIG. 14 is a diagram showing an overall sequence;

FIG. 15 is diagram showing routing;

FIG. 16 is diagram showing a message in an SOVD format;

FIG. 17 is a functional block diagram of an update master;

FIG. 18 is a functional block diagram of an OTA center;

FIG. 19 is diagram showing a configuration of a process-target specifier table;

FIG. 20 is a flowchart showing CGW processes;

FIG. 21 is a flowchart showing CGW processes;

FIG. 22 is a flowchart showing CGW processes;

FIG. 23 is a flowchart showing CGW processes;

FIG. 24 is a flowchart showing OTA center processes;

FIG. 25 is a functional block diagram;

FIG. 26 is diagram showing each functional block;

FIG. 27 is diagram showing an SOVD overview;

FIG. 28 is diagram showing a one-to-one conversion executor unit;

FIG. 29 is diagram showing details of a one-to-one conversion executor unit;

FIG. 30 is diagram showing a relationship with an OTA center;

FIG. 31 is diagram showing a one-to-many conversion executor unit; and

FIG. 32 is diagram showing a one-to-many conversion executor unit.

### DETAILED DESCRIPTION

For example, with the diversification of vehicle control, such as driving assistance functions and automated driving functions, an OTA (Over The Air) reprograming technology is provided to update software in an electronic control unit (hereinafter referred to as ECU) of the vehicle in a wireless manner. In OTA reprogramming, an OTA master on a vehicle side downloads software from an OTA center, delivers the software to an update target ECU and commands the update target ECU to update the software, whereby the update target ECU updates the software.

With the introduction of HPC (High-Performance Computer), a SOVD (Service-Oriented Vehicle Diagnostics) technology is provided as a next-generation diagnostic function. For example, in an SOVD service, when requesting an OTA master on a vehicle side to read ECU information, an OTA center transmits a read command to the OTA master without specifying which ECU is a read-target. Therefore, the OTA master needs to specify which ECU is the read-target; otherwise, the OTA master is not able to collect the ECU information designated by the read command from the OTA center. That is, upon accepting the read command from the OTA center, the OTA master needs to specify which ECU is the read-target.

This situation is not limited to reading the ECU information on the vehicle side but also can be expected when, for example, data is written to the ECU, and moreover can be expected when the SOVD service is for example diagnostics or log collection other than the OTA reprogramming. This situation is not limited to cases where an SOVD format is applied to center communication between the OTA center and the vehicle but is expected in cases where the SOVD format is applied to data communication between the vehicle and, for example, a proximity vehicle-external device connected to the vehicle in a wired manner and cases where the SOVD format is applied to data communication between an application in the vehicle and another element in the vehicle.

An object of the present disclosure is to, when a process-command based on a message or a file in an SOVD format compliant with SOVD communication specifications is accepted, appropriately specify a process-target corresponding to the accepted process-command and appropriately achieve an SOVD service.

A vehicular system according to one aspect of the present disclosure acquires a message or a file in an SOVD format compliant with SOVD communication specifications. A vehicle-side specifier information retention unit retains process-target specifier information indicating association between a process-command based on the message or the file in the SOVD format and connection destination information enabling to specify a process-target corresponding to the process-command. A process-command receiver unit accepts the process-command. When the process-command is accepted by the process-command receiver unit, a process-target specifier unit refers to the process-target specifier information and specifies the process-target corresponding to the accepted process-command based on the connection destination information.

A data communication system according to one aspect of the present disclosure includes a vehicle-external device that delivers a message or a file in an SOVD format compliant with SOVD communication specifications and a vehicular system that receives the message or the file in the SOVD format delivered from the vehicle-external device. In the vehicular system, a vehicle-side specifier information retention unit retains process-target specifier information indicating association between a process-command based on the message or the file in the SOVD format and connection destination information enabling to specify a process-target corresponding to the process-command. A process-command receiver unit accepts the process-command. When the process-command is accepted by the process-command receiver unit, a process-target specifier unit refers to the process-target specifier information and specifies the process-target corresponding to the accepted process-command based on the connection destination information.

A process-target specifying program according to one aspect of the present disclosure causes a control unit of a vehicular system, which vehicular system retains process-target specifier information indicating association between a process-command based on a message or a file in an SOVD format and connection destination information enabling to specify a process-target corresponding to the process-command, to perform a process-command receiving procedure of accepting the process-command based on the message or the file in the SOVD format and a process-target specifying procedure of, when the process-command is accepted by the process-command receiving procedure, referring to the process-target specifier information and specifying the process-target corresponding to the accepted process-command based on the connection destination information.

A process-target specifying method in a vehicular system according to one aspect of the present disclosure, which vehicular system retains process-target specifier information indicating association between a process-command based on a message or a file in an SOVD format and connection destination information enabling to specify a process-target corresponding to the process-command, includes a process-command receiving procedure of accepting the process-command based on the message or the file in the SOVD format and a process-target specifying procedure of, when the process-command is accepted by the process-command receiving procedure, referring to the process-target specifier information and specifying the process-target corresponding to the accepted process-command based on the connection destination information.

According to one aspect of the present disclosure, the process-target specifier information indicating the association between the process-command based on the message or the file in the SOVD format compliant with SOVD communication specifications and the connection destination information enabling to specify the process-target corresponding to the process-command is retained. When the process-command based on the message or the file in the SOVD format is accepted, the process-target specifier information is referred to and the process-target corresponding to the accepted process-command is specified based on the connection destination information. When the process-command based on the message or the file in the SOVD format compliant with SOVD communication specifications is accepted, it is possible to appropriately specify the process-target corresponding to the accepted process-command and appropriately achieve an SOVD service.

A vehicle-external device according to one aspect of the present disclosure delivers a message or a file in an SOVD format compliant with SOVD communication specifications to a vehicular system. A vehicle-external side specifier information retention unit retains process-target specifier information indicating association between a process-command based on the message or the file in the SOVD format and connection destination information enabling to specify a process-target corresponding to the process-command. A specifier information delivery unit delivers the process-target specifier information retained in the vehicle-external side specifier information retention unit to the vehicular system.

A specifier information delivery program according to one aspect of the present disclosure causes a vehicle-external device, which vehicle-external device delivers a message or a file in an SOVD format compliant with SOVD communication specifications to a vehicular system and retains process-target specifier information indicating association between a process-command based on the message or the file in the SOVD format and connection destination information enabling to specify a process-target corresponding to the process-command, to perform a specifier information delivery procedure of delivering the process-target specifier information to the vehicular system.

A specifier information delivery method in a vehicle-external device according to one aspect of the present disclosure, which vehicle-external device delivers a message or a file in an SOVD format compliant with SOVD communication specifications to a vehicular system and retains process-target specifier information indicating association between a process-command based on the message or the file in the SOVD format and connection destination information enabling to specify a process-target corresponding to the process-command, includes a specifier information delivery procedure of delivering the process-target specifier information to the vehicular system.

According to one aspect of the present disclosure, the process-target specifier information indicating the association between the process-command based on the message or the file in the SOVD format and the connection destination information enabling to specify the process-target corresponding to the process-command is retained and delivered to the vehicular system. In the vehicular system, by using the process-target specifier information delivered from the vehicle-external device, it is possible to appropriately specify the process-target corresponding to the accepted process-command and appropriately achieve an SOVD service.

Embodiments of the present disclosure will be described with reference to the accompanying drawings. Description of parts overlapping between a preceding embodiment and a later embodiment may be omitted.

### First Embodiment

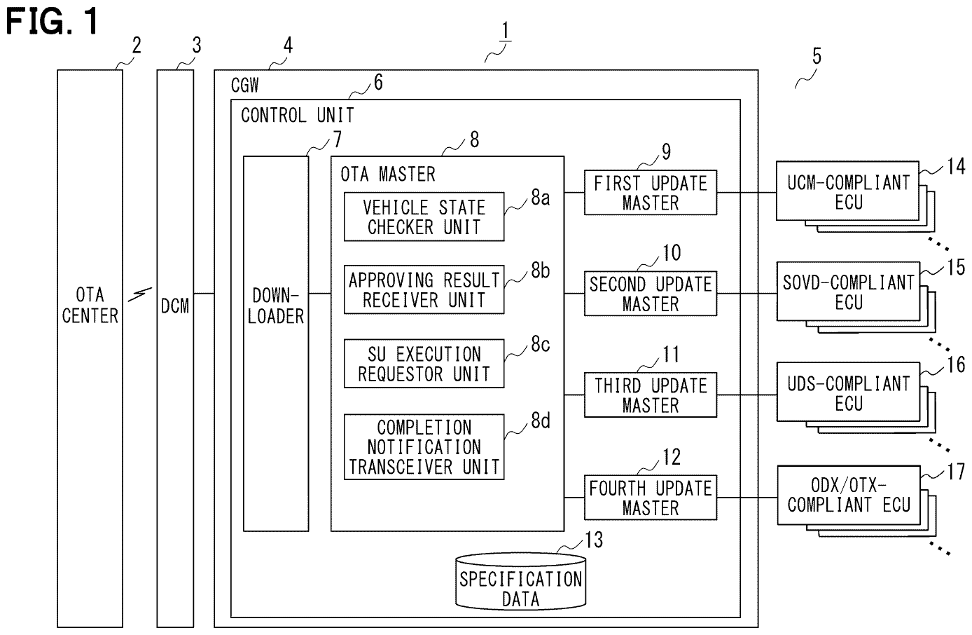

A first embodiment will be described with reference to FIG. 1 to FIG. 10. As shown in FIG. 1, a data communication system 1 includes an OTA (Over The Air) center 2 (corresponding to a vehicle-external device, a delivery source, and a transmission destination), a DCM (Data Communication Module) 3 (corresponding to an information source), and a CGW (Central Gateway) 4 (corresponding to a vehicular electronic control unit, and an information source). The DCM 3 is a vehicle-mounted communication device and performs data communication with the OTA center 2 via a communication network. The communication network includes, for example, such a mobile communication network as a 4G communication line and a 5G communication line, the Internet, WiFi (Wireless Fidelity) (registered trademark), etc. The DCM 3 and the CGW 4 may be integrated, and functions of the DCM 3 may be incorporated into the CGW 4. Functions of the DCM 3 and functions of the CGW 4 may be incorporated into a display or another device. The DCM 3 and the CGW 4, together with ECUs 14 to 17 described below, constitute a vehicular system 5.

By the DCM 3, data delivered from the OTA center 2 is forwarded to the CGW 4. The data delivered from the OTA center 2 to the DCM 3 is, for example, software for reprogramming. Center communication, which is data communication between the OTA center 2 and the CGW 4 (corresponds to vehicle-external communication and first communication), is applied with an SOVD format compliant with communication specifications of SOVD or a RestAPI format compliant with communication specifications of Rest (REpresentational State Transfer) API.

The CGW 4 includes a control unit 6. The control unit 6 includes, as its main component, a microcomputer (hereinafter referred to as “micom”) including a CPU, a ROM, a RAM, and I/O, etc., and executes controls via software processes by the CPU execution of a computer program stored in a non-transitory tangible storage medium, via hardware processes by a dedicated electronic circuit, so that the operation of the CGW 4 is controlled. The control unit 6 executes a format conversion program and a sequence generation program as the computer program. A format conversion method is executed by execution of the format conversion program by the control unit 6, and a sequence generation method is executed by execution of the sequence generation program by the control unit 6.

The CGW 4 may provide so-called HPC. The CGW 4 may include, for example, a System-on-Chip (SoC) as hardware thereof and Adaptive Platform as software thereof. The CGW 4 may include multiple VMs (virtual machines), and the multiple VMs may include VMs of various Platforms, such as a VM of Adaptive Platform and a VM of Classic Platform. The CGW 4 may, for example, function as so called a vehicle computer in an E-E architecture of the vehicle.

On a function-basis, the control unit 6 includes a downloader 7 (corresponding to a vehicle-external communicator unit and a first communicator unit), an OTA master 8, a first update master 9 (corresponding to a sequence generator executor unit), a second update master 10 (corresponding to a sequence generator executor unit), a third update master 11 (corresponding to a sequence generator executor unit), and a fourth update master 12 (corresponding to a sequence generator executor unit), and a specification data retention unit 13. When a download execution request from the OTA master 8 is input, the downloader 7 commands the DCM 3 to execute a download process. The downloader 7 downloads data from the OTA center 2 via the DCM 3 such that the data delivered from OTA center 2 is received at the DCM 3 and the received data is forwarded from the DCM 3.

The OTA master 8 has a function of overall management of SU (Software Update). On a function basis, the OTA master 8 includes a vehicle state checker unit 8a, an approving result receiver unit 8b, a SU execution requestor unit 8c, and a completion notification transceiver unit 8d.

The vehicle state checker unit 8a, for example, acquires and checks a vehicle state from an update target ECU. The approving result receiver unit 8b receives approving results for execution of the download process, the installation process, and the activation process from a vehicle-mounted HMI (Human Machine Interface) (not shown), for example, in progress of the software update.

Upon satisfaction of an installation execution condition, e.g., upon getting an approval to execute the installation process, the SU execution requestor unit 8c outputs an installation execution request to a corresponding update master among the update masters 9 to 12. Upon receipt of the installation execution request from the SU execution requestor unit 8c, the update master commands an update target ECUs to execute the installation process. Upon being commanded to execute the installation process, the update target ECU executes the installation process. Examples of software update manners include updates of firmware in units of ECU, updates in units of such software as applications, libraries, etc., in the ECU, and various other types.

Upon satisfaction of an activation execution condition, e.g., upon getting an approval to execute the activation process, the SU execution requestor unit 8c outputs an activation execution request to a corresponding update master among the update masters 9 to 12. Upon receipt of the activation execution request from the SU execution requestor unit 8c, the update master commands the update target ECU to execute the activation process. Upon being commanded to execute the activation process, the update target ECU executes the activation process.

Upon receipt of an installation completion notification from the update target ECU, the completion notification transceiver unit 8d causes the DCM 3 to transmit an installation completion notification to the OTA center 2. Upon receipt of an activation completion notification from the update target ECU, the completion notification transceiver unit 8d causes the DCM 3 to transmit the activation completion notification to the OTA center 2.

ECUs 14 to 17, respectively, are connected to the update masters 9 to 12 via the in-vehicle network. The in-vehicle network is, for example, CAN (Controller Area Network), Ethernet (registered trademark), etc.

The first update master 9 is connected to a UCM (Update & Configuration Management) compliant ECU 14 (corresponding to a delivery destination and an information source) via the in-vehicle network. The first update master 9 performs data communication with the UCM-compliant ECU 14 according to commands from the OTA master 8. A UCM format, which conforms to UCM communication specifications, is applied to ECU communication that is data communication between the first update master 9 and the UCM-compliant ECU 14 (corresponding to vehicle-internal communication and second communication). The UCM format is a format defined in AUTOSAR. The UCM-compliant ECU 14 is, for example, an ECU for providing UI (User Interface) and MM (MultiMedia) services. Functions of the first update master 9 may be arranged in the UCM-compliant ECU 14.

The UCM-compliant ECU 14 may provide so-called HPC. The UCM-compliant ECU 14 may, for example, include a SoC as hardware thereof and Adaptive Platform as software thereof. The UCM-compliant ECU 14 may include multiple VMs, and the multiple VMs may include VMs of various platforms, such as a VM of Adaptive Platform and a VM of the Classic Platform. The Classic Platform VM may be configured as a UDS-compliant VM. The UCM-compliant ECU 14 may, for example, function as what is called a domain controller or a zone ECU in the vehicle E-E architecture.

The second update master 10 is connected to the SOVD-compliant ECU 15 (corresponding to a delivery destination and an information source) via the in-vehicle network. The second update master 10 performs data communication with the SOVD-compliant ECU 15 according to commands from the OTA master 8. An SOVD format, which conforms to SOVD communication specifications, is applied to ECU communication that is data communication between the second update master 10 and the SOVD-compliant ECU 15 (corresponding to vehicle-internal communication and second communication). The SOVD format is a format defined using JSON (JavaScript Object Notation). The SOVD-compliant ECU 15 is, for example, an ECU for providing ADAS (Advanced Driving Assistant System) services. Functions of the second update master 10 may be arranged in the SOVD-compliant ECU 15.

The SOVD-compliant ECU 15 may provide so-called HPC. The SOVD-compliant ECU 15 may include, for example, a SoC as hardware thereof and Adaptive Platform as software thereof. The SOVD-compliant ECU 15 may include multiple VMs, and the multiple VMs may include VMs of various platforms, such as a VM of Adaptive Platform and a VM of Classic Platform. The Classic Platform VM may be configured as a UDS-compliant VM. The SOVD-compliant ECU 15 may, for example, function as what is called a domain controller or a zone ECU in the vehicle E-E architecture.

The third update master 11 is connected to a UDS (Unified Diagnostic Services) compliant ECU 16 (corresponding to a delivery destination and an information source) via the in-vehicle network. The third update master 11 performs data communication with the UDS-compliant ECU 16 according to commands from the OTA master 8. A UDS format, which conforms to UDS communication specifications, is applied to ECU communication that is data communication between the third update master 11 and the UDS-compliant ECU 16 (corresponding to vehicle-internal communication and second communication). The UDS format is an OEM-dependent format. The third update master 11 generates UDS-format messages and a communication sequence for the data communication with the UDS-compliant ECU 16 and performs the data communication, with reference to data on, for example, OEM proprietary formats that do not conform to the ODX or OTX standards. The UDS-compliant ECU 16 is, for example, an ECU for providing services of an engine-system, a hybrid (HV)-system, or an electric vehicle (EV) system.

The UDS-compliant ECU 16 may, for example, include a MCU (Micro Controller Unit) as hardware thereof and Classic Platform as software thereof.

The fourth update master 12 is connected to an ODX (Open Diagnostic Data Exchange)/OTX (Open Test Sequence Exchange) compliant ECU 17 (corresponding to a delivery destination and an information source) via the in-vehicle network. The fourth update master 12 performs data communication with the ODX/OTX-compliant ECU 17 according to commands from the OTA master 8. An ODX/OTX format, which conforms to ODX/OTX communication specifications, is applied to ECU communication that is data communication between the fourth update master 12 and the ODX/OTX-compliant ECU 17 (corresponding to vehicle-internal communication and second communication). The ODX/OTX format is a format defined using XML (eXtensible Markup Language). The fourth update master 12 generates a UDS format message and a communication sequence for the data communication with the ODX/OTX-compliant ECU 17 and performs the data communication, with reference to an ODX data described in the XML format according to the ODX standards or an OTX data described in the XML format according to the OTX standards.

The ODX/OTX-compliant ECU 17 may include, for example, an MCU as hardware thereof and Classic Platform as software thereof.

As described above, functions of the respective update masters 9 to 12 may be arranged in the CGW 4 or in the ECUs 14 to 17. The functions of the respective update master 9 to 12 may be arranged in an ECU in the vehicle other than the CGW 4 and the ECUs 14 to 17. When the functions of the update masters 9 to 12, respectively, are arranged in the ECUs 14 to 17, the update master 9 to 12 is connected to and performs the data communication with specific software in the ECU 14 to 17 (corresponding to vehicle-internal communication and second communication). For example, when the first update master 9 is arranged in the UCM-compliant ECU 14, the first update master 9 is connected to and performs data communication (corresponding to vehicle-internal communication and second communication) with software responsible for UCM in the UCM-compliant ECU 14. For example, when the second update master 9 is arranged in the SOVD-compliant ECU 15, the second update master 9 is connected to and performs data communication (corresponding to vehicle-internal communication and second communication) with software responsible for SOVD in the SOVD-compliant ECU 15.

Specification data retained in the specification data retention unit 13 includes various information on software update, such as information on output targets and an output sequence of installation commands, and information on output targets and an output sequence of activation commands.

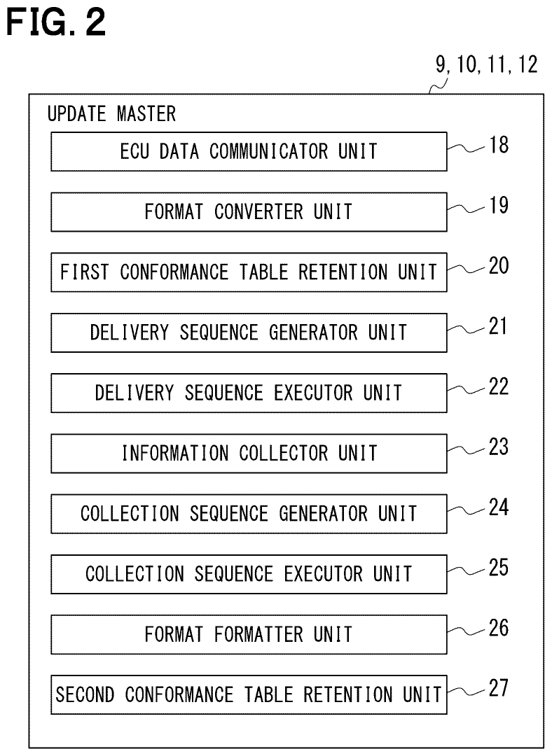

The update masters 9 to 12 will be described. As shown in FIG. 2, on a function basis, the update master 9 to 12 includes an ECU data communicator unit 18 (corresponding to a vehicle-internal communicator unit and a second communicator unit), a format converter unit 19, a first conformance table retention unit 20, a delivery sequence generator unit 21, a delivery sequence executor unit 22, an information collector unit 23, a collection sequence generator unit 24, a collection sequence executor unit 25, a format formatter unit 26, and a second conformance table retention unit 27.

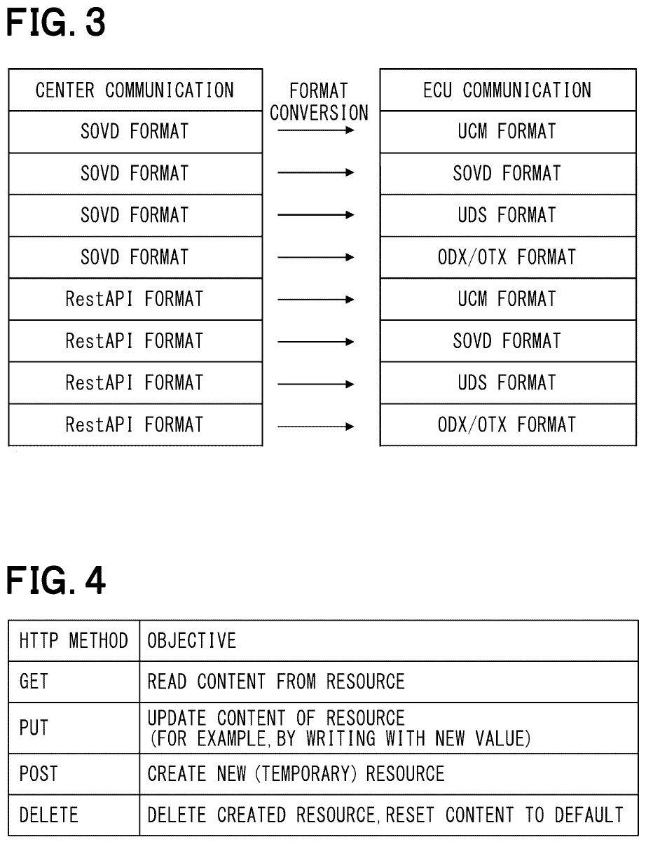

The ECU data communicator unit 18 performs the ECU communication with a respective corresponding ECU. The format converter unit 19 converts the format in the center communication according to specifications of the corresponding ECU. As shown in FIG. 3, the format converter unit 19 of the first update master 9 converts the format in the center communication to the UCM format since the first update master 9 performs the ECU communication with the UCM-compliant ECUs 14 according to the UCM communication specifications. The format converter unit 19 of the first update master 9 converts the SOVD format to the UCM format if the center communication is in the SOVD format. The format converter unit 19 of the first update master 9 converts the RestAPI format to the UCM format if the center communication is in the RestAPI format. If the center communication is in the RestAPI format, the RestAPI format may be converted to the SOVD format at the downloader 7 or the OTA master 8, and the SOVD format may be converted to the UCM format at the format converter unit 19 of the first update master 9.

The format converter unit 19 of the second update master 10 converts the format in the center communication to the SOVD format as necessary, since the second update master 10 performs the ECU communication with the SOVD-compliant ECUs 15 according to the SOVD communication specifications. If the center communication is in the SOVD format, the format converter unit 19 of the first update master 9 uses the SOVD format without conversion. The format converter unit 19 of the second update master 10 converts the RestAPI format to the SOVD format if the center communication is in the RestAPI format. If the center communication is in the RestAPI format, the RestAPI format may be converted to the SOVD format at the downloader 7 or the OTA master 8.

The format converter unit 19 of the third update master 11 converts the format in the center communication to the UDS format since the third update master 11 performs the ECU communication with the UDS-compliant ECU 16 according to the UDS communication specifications. The format converter unit 19 of the third update master 11 converts the SOVD format to the UDS format if the center communication is in the SOVD format. The format converter unit 19 of the third update master 11 converts the RestAPI format to the UDS format if the center communication is in the RestAPI format. If the center communication is in the RestAPI format, the RestAPI format may be converted to the SOVD format at the downloader 7 or the OTA master 8, and the SOVD format may be converted to the UDS format at the format converter unit 19 of the third update master 11.

The format converter unit 19 of the fourth update master 12 converts the format in the center communication with reference to the ODX/OTX data in the ODX/OTX format since the fourth update master 12 performs the data communication with the ODX/OTX-compliant ECU 17 according to the UDS communication specifications based on the ODX/OTX data. The format converter unit 19 of the fourth update master 12 converts the SOVD format with reference to the ODX/OTX data in the ODX/OTX format if the center communication is in the SOVD format. The format converter unit 19 of the fourth update master 12 converts the RestAPI format with reference to the ODX/OTX data in the ODX/OTX format if the center communication is in the RestAPI format. In addition, if the center communication is in the RestAPI format, the RestAPI format is converted to the SOVD format at the downloader 7 or the OTA master 8, and the format conversion on the SOVD format is performed at the format converter unit 19 of the fourth update master 1 with reference to the ODX/OTX data in the ODX/OTX format.

As described, it is assumed that a case of performing the center communication in the RestAPI format coexists with a case of performing the center communication in the SOVD format. Therefore, a mechanism is required for the vehicle to distinguish whether the format in the center communication from the OTA center 2 to the vehicle is the RestAPI format or the SOVD format. This mechanism in the present embodiment is such that a format identifier, such as a tag, indicating whether the format is the RestAPI format or the SOVD format is added to the center communication, and an element of the vehicle which is, for example, any one of the downloader 7, the OTA master 8 and the format converter unit 19 distinguishes based on the format identifier whether the format is the RestAPI format or the SOVD format. Similarly, with respect to the center communication from the vehicle to the OTA center 2, a tag or another format identifier is added to the center communication and the OTA center 2 distinguishes based on the format identifier whether the communication is in the RestAPI format or the SOVD format.

In the center communication from the vehicle to the OTA center 2, the vehicle may selectively use the RestAPI format or the SOVD format depending on, for example, data types. For example, the SOVD format may be used to transmit a message (corresponding to a second type), and the RestAPI format may be used to transmit a file (corresponding to a first type). Similarly, the OTA center 2 may selectively use the RestAPI format or the SOVD format depending on data types.

The first conformance table retention unit 20 retains a first conformance table for format conformance at the format conversion. By using the first conformance table, the format converter unit 19 converts the SOVD format used in the center communication into a format that conforms to the SOVD-noncompliant communication specifications. In this case, the first conformance table retained in the first conformance table retention unit 20 may be transmitted from the OTA center 2 or prepared in advance in the update masters 9 to 12. That is, the format converter unit 19 may receive the SOVD format and the first conformance table from the OTA center 2 and may use the received SOVD format and first conformance table. Alternatively, the format converter unit 19 may use the SOVD format and the first conformance table prepared in advance. The first conformance table functions as a conversion map for format conversion.

When converting the SOVD format, the format converter unit 19 interprets contents expressed in the SOVD format and converts the SOVD format into messages interpretable by the corresponding ECU. For example, because messages corresponding to “SID 22” and “DID1000” requesting vehicle speed information acquisition from a corresponding ECU are unavailable in the SOVD format, the format converter unit 19 adds a message corresponding to “SID 22” and “DID1000” when requesting vehicle speed information acquisition from a corresponding ECU. The format converter unit 19 refers to the first conformance table to add messages as described above.

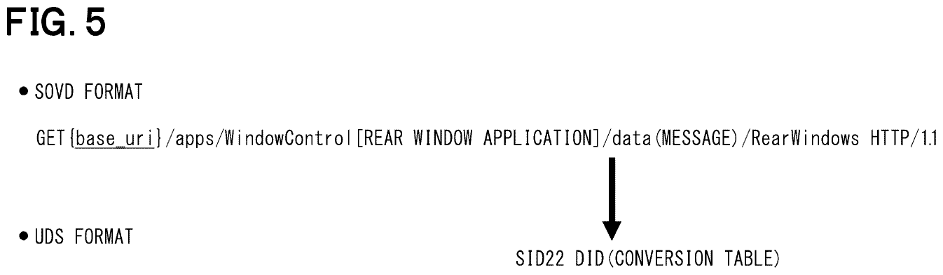

As shown in FIG. 4, there are four HTTP methods used in the SOVD format, which are GET, PUT, POST, and DELETE. The format converter unit 19 converts the SOVD format “GET”, for example, into the UDS format through replacing the “data (message)” part with “SID 22 DID (conversion table)”, as shown in FIG. 5. The format converter unit 19 compensates for a message that is absent in the SOVD format and thereby attain the center communication in the SOVD format and the ECU communication in the SOVD-noncompliant format not compliant with the SOVD.

The delivery sequence generator unit 21 generates a delivery sequence for managing a delivery order in which messages are delivered to the ECU, according to the SOVD-noncompliant format obtained via the conversion by the format converter unit 19. Managing the delivery order refers to changing the delivery order of messages and/or adding a lacking message. Changing the delivery order of messages may be specified from, for examples, contents of the specification data. The lacking messages that are to be added are, for example, messages corresponding to services that are not defined in the SOVD format (e.g., services corresponding to SID 34, SID 36, and SID 37). The messages that are to be added because of the shortage may be specified from, for example, the contents of the specification data and the first conformance table. In addition, the OTA center 2 may generate the delivery sequence, and the delivery sequence generated by the OTA center 2 may be used. Alternatively, the SOVD message alone is transmitted to the corresponding ECU, and the corresponding ECU generates the delivery sequence, so that the delivery sequence generated by the ECU is used.

The first conformance table, which functions as the format conversion map described above, maps default post-conversion messages corresponding to messages in the SOVD format transmitted from the OTA center 2 and default delivery sequences corresponding to the messages in the SOVD format transmitted from the OTA center 2, and the delivery sequence generator unit 21 may generate the delivery sequence by using the first conformance table. In this case, the delivery sequence generator unit 21 may generate a sequence by arranging the default post-conversion messages and the default delivery sequences according to the contents of the specification data with regard to an order in which commands to start processes are transmitted to the target ECUs and/or process start conditions (the approval required or not required, the installation in the parked state or not., etc.)

As mentioned above, the delivery sequence generator unit 21 generates a sequence for managing the delivery. The sequence for managing the delivery may include arbitration for a process separate from this delivery. The arbitration is, for example, which one is prioritized among this delivery and the separate process. For example, the sequence for managing delivery of messages to an ECU based on data transmitted from a certain source (e.g., OTA center 2) may include the arbitration for transmission of messages from a separate source (e.g., a wired tool (not shown) connected to the vehicle in the wired manner) to the ECU. Examples of the transmission of messages from the separate source to the ECU include a case where messages transmitted from the separate source according to different communication specifications (e.g., UDS) are delivered to the ECU and a case where messages based on data transmitted from the separate source by the SOVD services are delivered to the ECU. This kind of arbitration for a separate process may be included in the below-described collection sequence. Concrete contents of the arbitration employable are various. For example, the arbitration is such that when the wired tool serving as one delivery source is prioritized over the OTA center 2 serving as another delivery source, messages based on data transmitted from the OTA center 2 by the SOVD service are delivered to the ECU on condition that the wired tool connected to the vehicle is not detected.

With respect to “SID22” for example, the delivery sequence generator unit 21 uses it as it is transmitted from the OTA center 2. With respect to “SID10” and “SID27” for example, the delivery sequence generator unit 21 adds messages as these are not transmitted from the OTA center 2. With respect to “SID34”, “SID36” and “SID37” for example, the delivery sequence generator unit 21 adds messages as these are unable to be expressed in the SOVD format. The delivery sequence executor unit 22 executes the delivery sequence generated by the delivery sequence generator unit 21.

The information collector unit 23 collects ECU information (corresponding to device information) retained in the ECUs 14 to 17. The ECU information includes ECU identification information for enabling the ECU to be identified, version information indicating hardware version, version information indicating software version, etc.

The collection sequence generator unit 24 generates a collection sequence for collecting the ECU information (corresponding to information) retained in the ECU 14 to 17. The collection sequence may be generated by the ECU 14 to 17. The collection sequence executor unit 25 executes the collection sequence generated by the collection sequence generator unit 24.

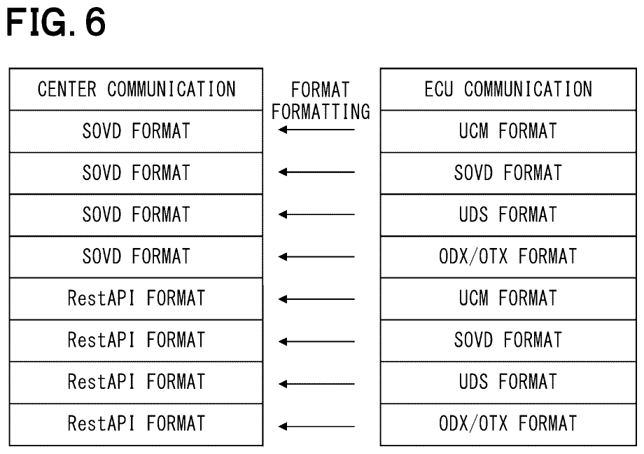

From the format in the ECU communication with the respective corresponding ECU, the format formatter unit 26 forms the format for the center communication. That is, as shown in FIG. 6, from the UCM format, the format formatter unit 26 of the first update master 9 forms the format for the center communication since the first update master 9 performs the ECU communication with the UCM-compliant ECU 14 according to the UCM communication specifications. From the UCM format, the format formatter unit 26 of the first update master 9 forms the SOVD format if the center communication is in the SOVD format. From the UCM format, the format formatter unit 26 of the first update master 9 forms the RestAPI format if the center communication is in the RestAPI format.

From the SOVD format, the format formatter unit 26 of the second update master 10 forms the format for the center communication as necessary, since the second update master 10 performs the ECU communication with the SOVD-compliant ECU 15 according to the SOVD communication specifications. If the center communication is in the SOVD format, the format formatter unit 26 of the second update master 10 uses the SOVD format as it is without forming the SOVD format. From the SOVD format, the format formatter unit 26 of the second update master 10 forms the RestAPI format if the center communication is in the RestAPI format.

From the UDS format, the format formatter unit 26 of the third update master 11 forms the format for the center communication since the third update master 11 performs the ECU communication with the UDS-compliant ECUs 16 according to the UDS communication specifications. The format formatter unit 26 of the third update master 11 forms the SOVD format from the UDS format if the center communication is in the SOVD format. The format formatter unit 26 of the third update master 11 forms the RestAPI format from the UDS format if the center communication is in the RestAPI format.

The format formatter unit 26 of the fourth update master 12 forms the format for the center communication with reference to the ODX/OTX data in the ODX/OTX format since the fourth update master 12 performs the ECU communication with the ODX/OTX-compliant ECU 17 according to the UDS communication specifications. The format formatter unit 26 of the fourth update master 12 forms the SOVD format from the UDS format with reference to the ODX/OTX data in the ODX/OTX format if the center communication is in the SOVD format. The format formatter unit 26 of the fourth update master 12 forms the RestAPI format from the UDS format with reference to the ODX/OTX data in the ODX/OTX format if the center communication is in the RestAPI format.

The second conformance table retention unit 27 retains a second conformance table for format conformance at the format formatting. By using the second conformance table, the format formatter unit 26 forms the formats for the center communication from the formats of the ECU communications with the respective corresponding ECU. In this case, to the information received from the ECU 14 to 17, the format formatter unit 26 adds information indicating which ECU 14 to 17 is a source of the information, by using the second conformance table.

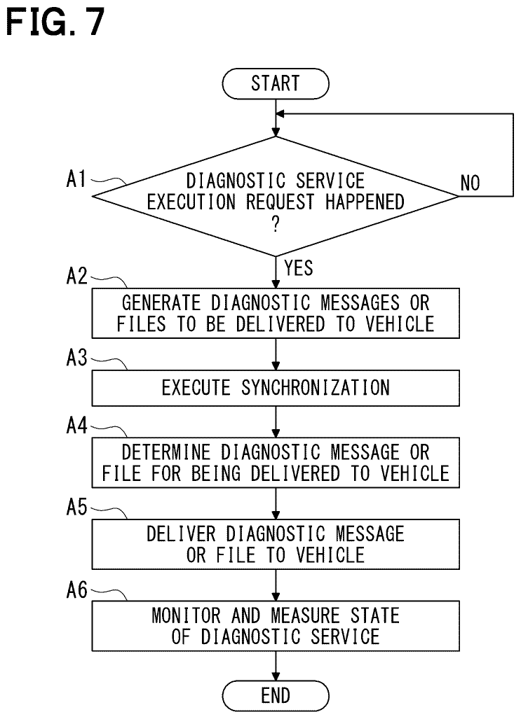

Next, operations of the above configuration will be described with reference to FIGS. 7 to 10. Processes at downloading and uploading will be described in turn for the case of performing diagnosis as an SOVD service.

### (1) Process at Downloading

A center-side process performed by OTA center 2 at downloading and a vehicle-side process performed by the CGW 4 at downloading will be described in turn.

### (1-1) Center-side Process Performed by OTA Center 2 at Downloading (see FIG. 7).

Upon start of the center-side process, the OTA center 2 determines whether or not a request to execute a diagnostic service has happened (A1). Upon determining that the request to execute the diagnostic service has happened (A1: YES), the OTA center 2 generates diagnostic messages or files to be delivered to the vehicle (A2). Upon receipt of synchronization information transmitted from the vehicle, the OTA center 2 executes the synchronization with the vehicle (A3).

After executing the synchronization with the vehicle, the OTA center 2 determines the diagnostic message or file for being delivered to the vehicle (A4) and transmits the determined diagnostic message or file to the vehicle (A5). Upon receipt of a state and a result of the diagnostic sequence transmitted from the vehicle, the OTA center 2 monitors and measures the state of the diagnostic service according to the received state and result of the diagnostic sequence (A6), and then ends the center-side process.

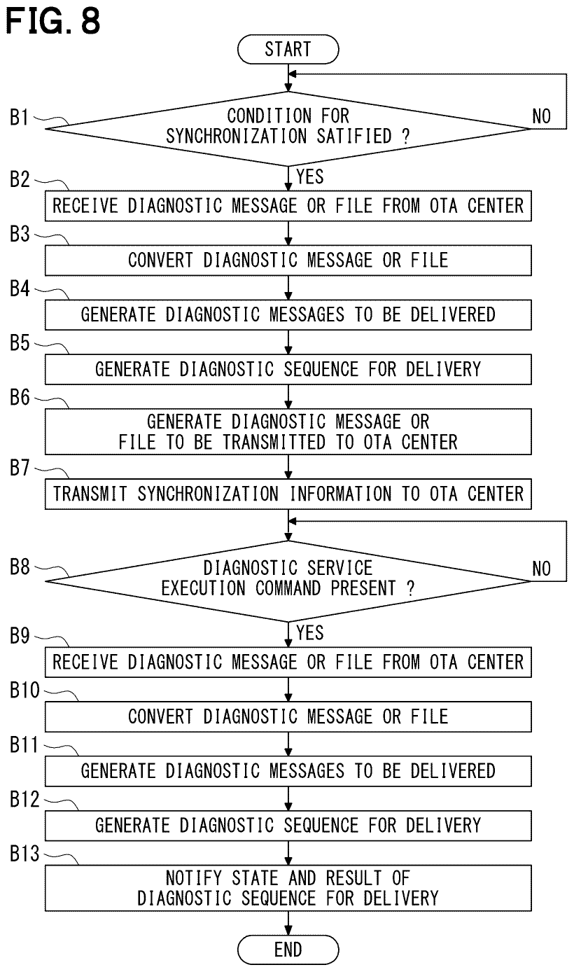

### (1-2) Vehicle-side Process Performed by CGW 4 at Downloading (see FIG. 8).

In the CGW 4, upon start of the vehicle-side process, the control unit 6 determines whether a condition for synchronization with the OTA center 2 is satisfied (B1). Upon determining that the condition for synchronization with the OTA center 2 is satisfied (B1: YES) and receiving a diagnostic message or file from the OTA center 2 (B2), the control unit 6 converts the received diagnostic message or file (B3).

The control unit 6 performs the above-described format conversion and generates diagnostic messages to be delivered to a diagnosis target ECU (B4, corresponding to a format conversion procedure). The control unit 6 generates a diagnostic sequence (corresponding to a delivery sequence) for delivery to the diagnosis target ECU (B5, corresponding to a delivery sequence generation procedure), executes the generated diagnostic sequence to communicate with the diagnosis target ECU (corresponding to a communication procedure). The control unit 6 generates a diagnostic message or file to be transmitted to the OTA center 2 (B6) and transmits the synchronization information to the OTA center 2 (B7).

The control unit 6 determines whether a command from the OTA center 2 to execute the diagnostic service is present or absent (B8). When it is determined that the command from the OTA center 2 to execute the diagnostic service is present (B8: YES) and the diagnostic message or file is received from the OTA center 2 (B9), the control unit 6 converts the received diagnostic message or file (B10).

The control unit 6 performs the format conversion described above and generates the diagnostic messages to be delivered to the diagnosis target ECU (B11, corresponding to a format conversion procedure). The control unit 6 generates a diagnostic sequence (corresponding to a delivery sequence) for delivery to the diagnosis target ECU (B12, corresponding to a delivery sequence generation procedure), executes the generated diagnostic sequence to communicate with the diagnosis target ECU (corresponding to a communication procedure). The control unit 6 transmits the state and result of the diagnostic sequence for delivery to the diagnosis target ECU to the OTA center 2 (B13) and ends the vehicle-side process.

### (2) Process at Uploading

A center-side process performed by the OTA center 2 at uploading and a vehicle-side process performed by the CGW 4 at uploading will be described in turn.

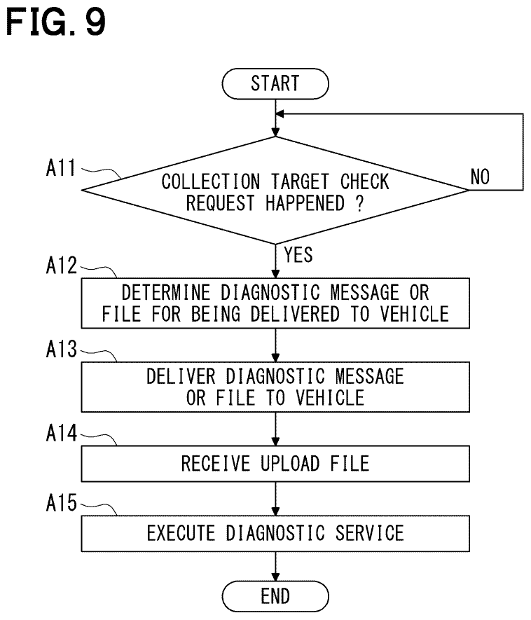

### (2-1) Center-side Process Performed by OTA Center 2 at Uploading (see FIG. 9).

Upon start of the center-side process, the OTA center 2 determines whether or not a collection target check request from the vehicle has happened (A11). Upon determining that the collection target check request from the vehicle has happened (A11: YES), the OTA center 2 determines the diagnosis message or file for being delivered to the vehicle (A12) and transmits the determined diagnosis message or file to the vehicle (A13). Upon receipt of the upload file transmitted from the vehicle (A14), the OTA center 2 executes the diagnostic service (A15) and ends the center-side process.

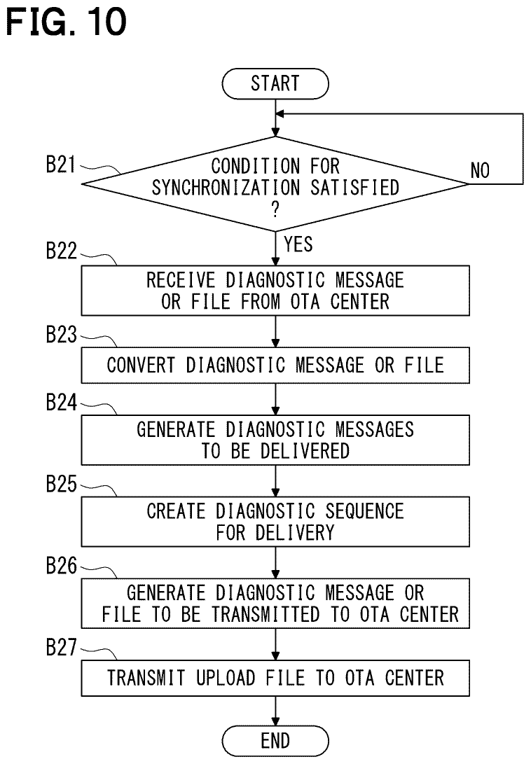

### (2-2) Vehicle-side Process Performed by CGW 4 at Uploading (see FIG. 10).

In the CGW 4, upon start of the vehicle-side process, the control unit 6 determines whether the condition for synchronization with the OTA center 2 is satisfied (B21). When it is determined that the condition for synchronization condition with the OTA center 2 is satisfied (B21: YES) and the diagnostic message or file is received from the OTA center 2 (B22), the control unit 6 converts the received diagnostic message or file (B23). The control unit 6 generates diagnostic messages to be delivered to the diagnosis target ECU (B24), generates the diagnostic sequence (corresponding to a collection sequence) for delivery to the diagnosis target ECU (B25), and executes the generated diagnostic sequence to communicate with the diagnosis target ECU. The control unit 6 performs the above-described format forming and generates the diagnostic message or file to be transmitted to the OTA center 2 (B26), and the control unit 6 transmits the upload file to the OTA center 2 (B27) and ends the vehicle side process.

The above examples show the download and upload processes when diagnostics are performed as SOVD services, but the same is applicable when OTA reprogramming, remote diagnostics, customization, etc., are performed as SOVD services. That is, the configuration to convert the SOVD format to the SOVD-noncompliant format, the configuration to generate the delivery sequence for managing an order in which messages are delivered, the configuration to generate the collection sequence for collecting the ECU information, and the configuration to form the SOVD format from the SOVD-noncompliant format are applicable to download processes and upload processes when the OTA reprogramming, the remote diagnostics, and the customization are performed.

The above-described first embodiment provides following operational effects. When the center communication with the OTA center 2 is the data communication in the SOVD format and the delivery destination of the message or the file based on the SOVD format is an ECU that is not compliant with SOVD, the CGW 4 converts the SOVD format in the center communication to the SOVD-noncompliant format and performs the ECU communication with the SOVD-noncompliant ECU according to the SOVD-noncompliant format obtained via the conversion. By converting the SOVD format in the center communication into the SOVD-noncompliant format and performing the ECU communication according to the SOVD-noncompliant format obtained via the conversion, it is possible to appropriately achieve SOVD services to ECUs not compliant with SOVD.

Although the first embodiment shows an example configuration in which the update master 9 to 12 in the CGW 4 converts the SOVD format to the SOVD-noncompliant format, it is possible to employ a configuration described below in the second embodiment in which, in the CGW 4, the OTA master 8 converts the SOVD format message to a generalized-format messages and the update master 9 to 12 converts the generalized-format message to the SOVD-noncompliant format. The generalized-format messages (hereinafter also referred to as generalized messages) are messages for the OTA master 8 to communicate with multiple update masters 9 to 12, and may be, for example, generalization of UDS-compliant messages by extension. By extension, the generalized messages can convey messages regarding services that are absent in the UDS standards, for example.

The delivery sequence for managing the order in which messages are delivered is generated according to the SOVD-noncompliant format, and the ECU communication is performed according to the generated delivery sequence. By generating the delivery sequence for managing the order in which messages are delivered, it is possible to appropriately achieve SOVD services to SOVD-noncompliant ECUs.

From the SOVD-noncompliant formats acquired from the SOVD-noncompliant ECUs, the SOVD formats are formed. By forming the SOVD formats from the SOVD-noncompliant formats in the ECU communication, it is possible to appropriately achieve SOVD services to SOVD-noncompliant ECUs.

The collection sequence for collecting the ECU information from ECU is generated and the ECU communication is performed according to the collection sequence. By generating the collection sequence for collecting the ECU information from ECU, it is possible to appropriately achieve SOVD services to SOVD-noncompliant ECUs.

The format identifier such as a tag indicating whether the format is the RestAPI format or the SOVD format is added to the center communication, and the vehicle distinguishes whether the format is the RestAPI format or the SOVD format based on the format identifier. Even when the center communication in the SOVD format coexists with that in the RestAPI format, it is possible to appropriately perform the center communication.

### Second Embodiment

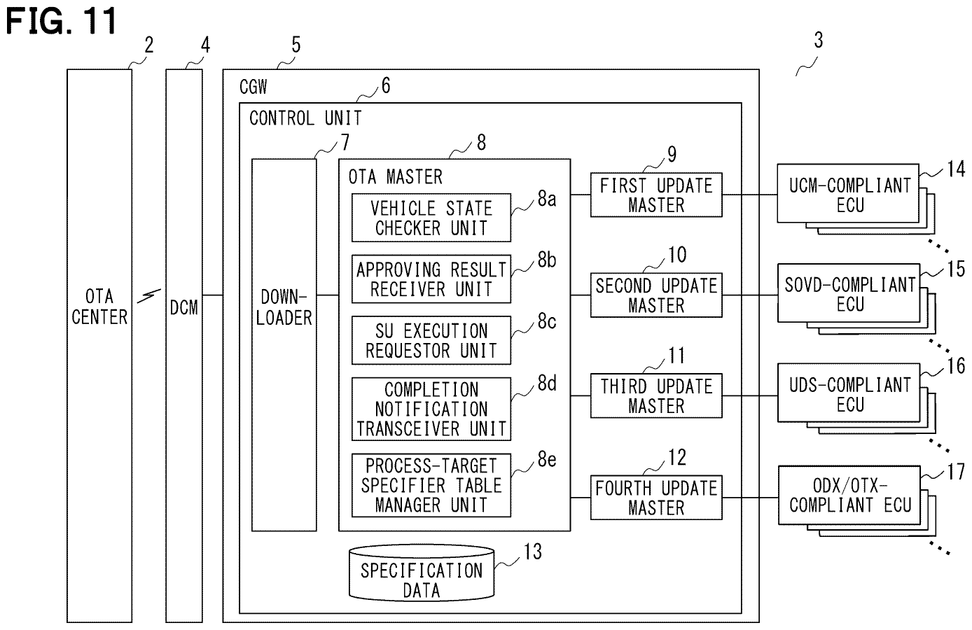

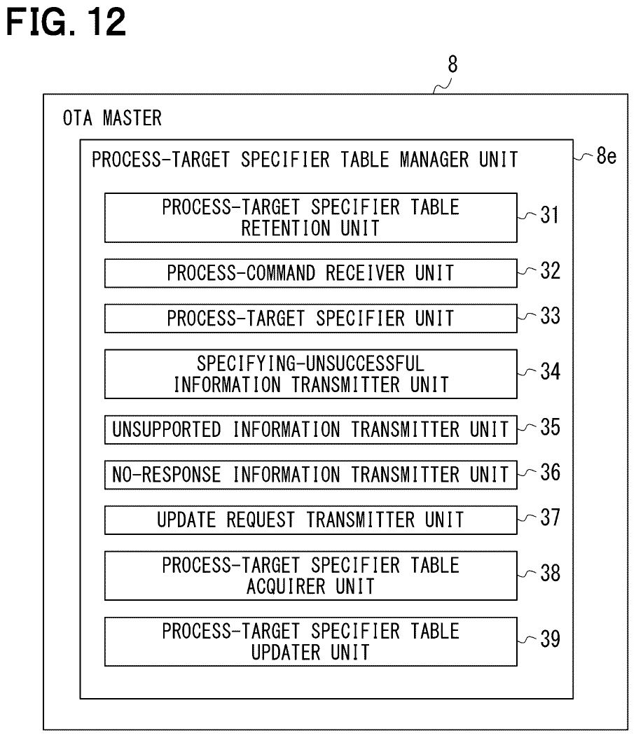

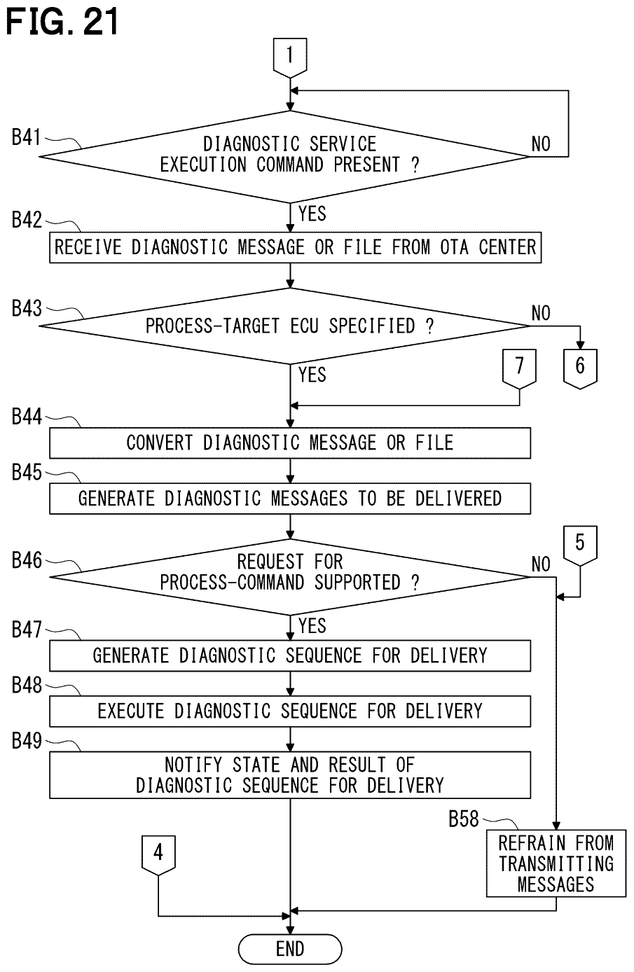

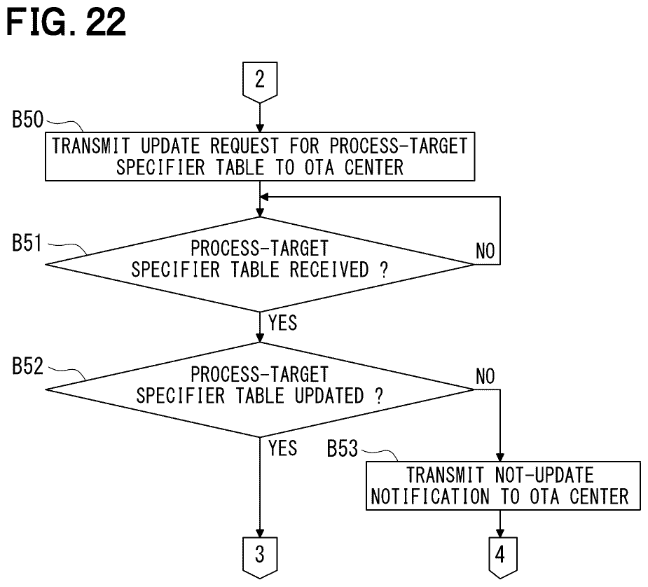

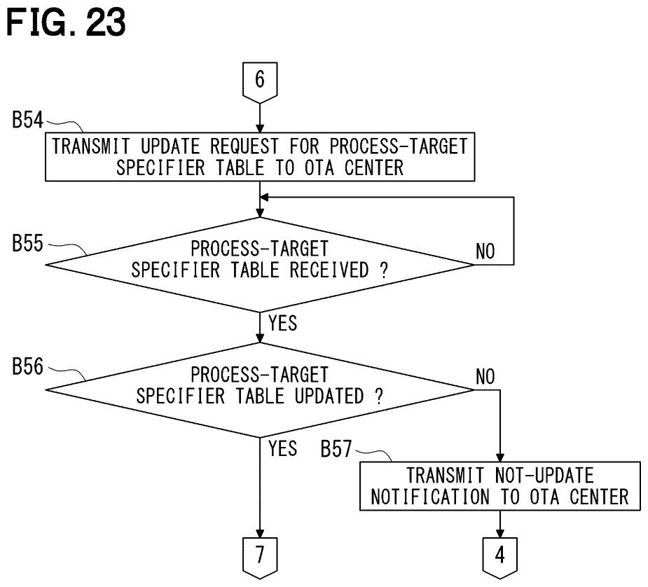

A second embodiment will be described with reference to FIG. 11 to FIG. 24. As shown in FIG. 11, the OTA master 8 includes a process-target specifier table manager unit 8e in addition to the vehicle state checker unit 8a, the approving result receiver unit 8b, the SU execution requestor unit 8c, and the completion notification transceiver unit 8d described above in the first embodiment. As shown in FIG. 12, on a function basis, the process-target specifier table manager unit 8e includes a process-target specifier table retention unit 31 (corresponding to a vehicle-side specifier information retention unit), a process-command receiver unit 32, a process-target specifier unit 33, a specifying-unsuccessful information transmitter unit 34, a unsupported information transmitter unit 35, a no-response information transmitter unit 36, an update request transmitter unit 37, a process-target specifier table acquirer unit 38 (corresponding to a specifier information acquirer unit), and a process-target specifier table updater unit 39 (corresponding to a specifier information updater unit).

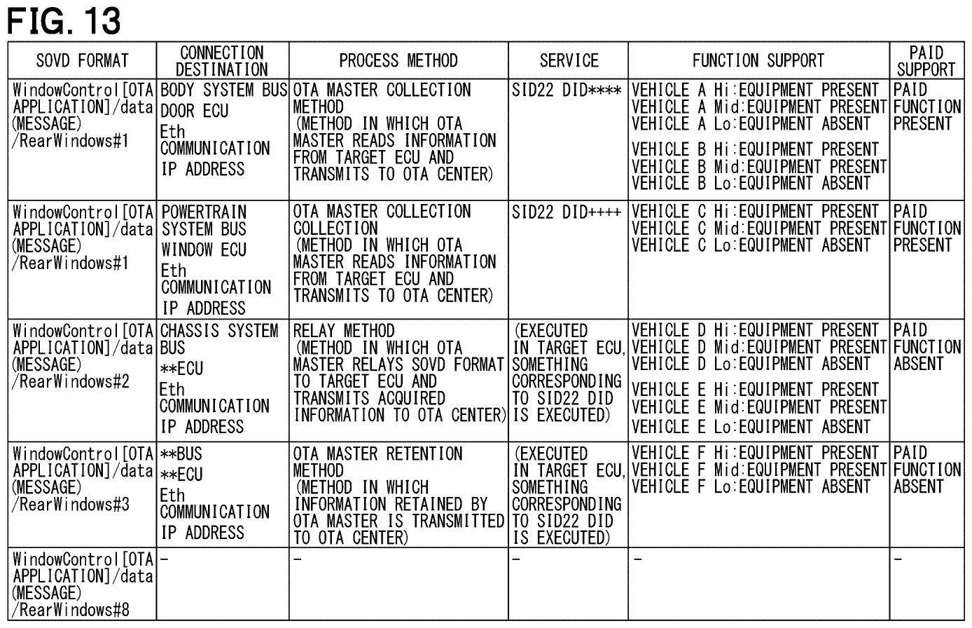

The process-target specifier table (corresponding to process-target specifier information) retained in the process-target specifier table retention unit 31 is a table indicating association between process-commands based on the SOVD format messages or files and a variety of information corresponding to the process-commands, as shown in FIG. 13. In the process-target specifier table, units of information are information on SOVD formats, connection destinations, process methods, services, function supports, and paid supports. Specifically, the process-target specifier table associates the process-commands based on the SOVD format messages or files with the information on the connection destinations, the process methods, the services, the function supports, and the paid supports corresponding to the process-commands. The present embodiment shows an example in which the process-target specifier table is retained in the OTA master; however, the process-target specifier table is not limited to being retained in the OTA master and may be retained in, for example, a specific ECU or any other locations in the vehicular system 3.

The information on the connection destination (corresponding to connection destination information) indicates information that enables a process-target ECU to be specified. The process-target ECU may be referred to as a target ECU. For example, “body system bus, door ECU, Eth communication, IP address” indicates that the process-target ECU is a door ECU connected to the body system bus and specifiable by the IP address in the Ethernet communication. The connection destination information may be, for example, information that enables one of elements of the HPC functioning as an integrated ECU to be specified as the process-target. For example, assuming an HPC including multiple VMs connected to a virtual CAN bus belonging to the body system bus, the connection destination information may be, for example, “body system bus, door ECU” to specify that a VM connected to the body system bus and functioning as the door ECU among the multiple VMs is the process-target. Assuming an HPC including multiple SoCs communicatively connected by Ethernet communication, the connection destination information may be information that enables to specify which of the SoCs is the process-target by the IP address in the Ethernet communication.

The information on the process method (corresponding to process method information) indicates information that enables to specify the process method for the process-target ECU. The processing methods include an OTA master collection method, a relay method, and an OTA master retention method.

The OTA master collection method is a method in which the OTA master 8 interprets the SOVD format from the OTA center 2, reads information from the target ECU, and transmits the read information to the OTA center 2. In the OTA master collection method, the OTA master 8 transmits the SOVD message or the generalized message converted from the SOVD message to, among the update masters 9 to 12, the update master that corresponds to the connection target being the process-target. Upon receipt of the SOVD message or generalized message from the OTA master 8, the update master 9 to 12 converts the received SOVD message or generalized message into the appropriate format and generates the sequence.

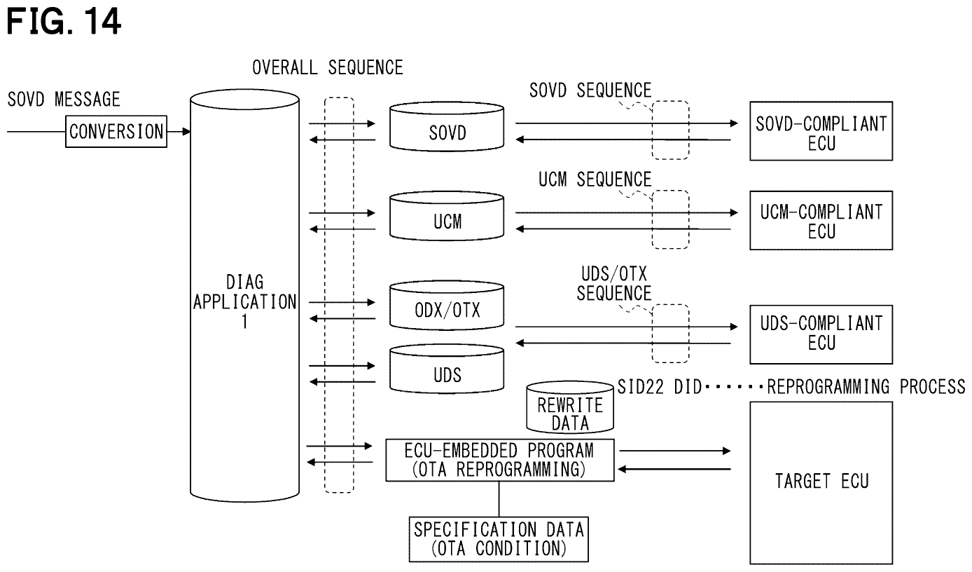

When the process method is the OTA master collection method and there are multiple connection targets being the process-targets (e.g., all the ECUs mounted to the vehicle or all ECUs belonging to a specific category, etc.), a sequence also exists between the OTA master 8 and the update masters 9 to 12, as shown in FIG. 14. A functional block named a diagnostic application shown in FIG. 14 corresponds to the OTA master 8 described in FIG. 1 and FIG. 11, and functional blocks named SOVD, UCM, ODX/OTX, and UDS shown in FIG. 14 correspond to the second update master 10, the first update master 9, the third update master 11, and the fourth update master 12, respectively. In the example shown in FIG. 14, the functional blocks SOVD, UCM, ODX/OTX, and UDS are software updatable by so called SOTA and are updatable by, for example, replacing an execution file or a configuration file in a file system of Adaptive Platform. Functional blocks named SOVD-compliant ECU and UCM-compliant ECU shown in FIG. 14, respectively, correspond to the SOVD-compliant ECU 15 and the UCM-compliant ECU 14 described in FIGS. 1 and 11. The UDS-compliant ECU shown in FIG. 14 corresponds to the UDS-compliant ECU 16 and the ODX/OTX-compliant ECU 17 described in FIGS. 1 and 11. As described above, the ODX/OTX-compliant ECU 17 also communicates according to UDS. Therefore, the UDS-compliant ECU 16 and the ODX/OTX-compliant ECU 17 described in FIGS. 1 and 11 are collectively referred to as the UDS-compliant ECU in FIG. 14.

The ECU-embedded program (OTA reprogramming) shown in FIG. 14 differs from the functional blocks SOVD, UCM, ODX/OTX, and UDS in that it is an ECU-embedded program. The ECU-embedded program (OTA reprogramming) corresponds to the first update master 9, the second update master 10, the third update master 11 and the fourth update master 12 described in FIGS. 1 and 11, and the ECU-embedded program operates to thereby perform the communications with the UCM-compliant ECU 14, the SOVD-compliant ECU 15, the UDS-compliant ECU 16, and the ODX/OTX-compliant ECU 17 which correspond to a functional block named a target ECU in FIG. 14.

In this case, the sequence between the OTA master 8 and the update masters 9 to 12 corresponding to the process-command from the OTA center 2 and the sequence between each update master and the connection target corresponding to the SOVD message or the generalized message are predetermined as default sequences in a map or the like.

The default sequence includes checking an order in which process start commands are issued and checking satisfaction of the process start condition prior to the process start command by, for example, checking the vehicle state and/or the approval (when required). At this time, with reference to the information on function support and paid support described below, a sequence is generated by removing “a process not supported in the host vehicle” from the default sequence. In the case of software updates, the sequence is generated by arranging the order in which processes commands are transmitted to the update masters 9 to 12 and/or the target ECUs and arranging the process start condition according to the contents of the specification data (the approval required or not required, the installation in the parked state or not, etc.).

If the OTA master 8 fails to generate the sequence between the OTA master 8 and the update masters 9 to 12, the OTA master 8 transmits error formation indicating the failure to generate the sequence along with a reason for the failure to the OTA center 2 being the source of the SOVD message. At this time, the OTA master 8 may request the OTA center 2 being the source of the SOVD message for at least one of: the latest version of the map for generating the sequence; and the latest version of the software for generating the sequence using the map. Similarly, when the update master 9 to 12 fails to generate the sequence, the update master 9 to 12 transmits the error information indicating the failure to generate the sequence along with a reason for the failure to the OTA master 8 being the sender of the SOVD format message or the generalized message. In this case, the OTA master 8 may request the OTA center 2 being the source of the SOVD message for at least one of: the latest version of the map for the update master 9 to 12 to generate the sequence; and the latest version of the software for generating the sequence using the map.

The relay method is a method in which the OTA master 8 relays the SOVD format from OTA center 2 to the target ECU without interpreting it and transmits the information acquired from the target ECU to the OTA center 2. In this case, the target ECU interprets the SOVD format. In the relay method, the OTA master 8 transmits the SOVD message to the target ECU (SOVD-compliant ECU) being the connection target and also the process-target by bypassing the second update master 10. An example of processes at the transmission destination is such that the SOVD-compliant ECU, such as a domain controller ECU or a zone ECU, specifies the process-target and the process method with reference to the above-described process-target specifier table and, if necessary, performs UDS conversion, etc. A response to the SOVD message from the transmission destination is transmitted from the DCM 3 to the OTA center 2 via the OTA master 8.

The OTA master retention method is a method in which the information on the target ECU is retained in the OTA master 8 and the retained information is transmitted to the OTA center 2. In the OTA master retention method, the OTA master 8 transmits SOVD messages or generalized messages to the update masters 9 to 12 corresponding to the target ECUs being the connection destinations and also the process-targets periodically or in response to occurrence of preset events, and acquires information corresponding to the SOVD messages or the generalized messages from the target ECUs and retrains the information. The information that is acquired from the target ECUs being the connection targets and retained is, in one use case, uploaded in response to the SOVD message from the outside, and is, in another use case, uploaded to the outside periodically or in response to a given event, e.g., an event designated for each upload target information.

In the OTA master retention method, examples of the information on the target ECU retained in the OTA master 8 and transmitted to the transmission destination include the information retained in the OTA master 8 via periodic execution of the service corresponding to “SID 22, DID***” shown in FIG. 13. The target ECU is not limited to an ECU separated from the ECU including the OTA master 8 and may be the ECU including the OTA master 8. The OTA master collection method, the relay method, and the OTA master retention method, respectively, correspond to a collection method, a relay method, and a retention method. The OTA center 2 corresponds to a delivery source and a transmission destination.

The information on the service indicates the message corresponding to the SOVD format. The information on the function support (corresponding to support information) refers to information that enables to specify whether or not the process-target ECU supports the process-command as the request. For example, in the case of “Vehicle A”, high grade and middle grade are “equipment present” and support the process-command as the request, while low grade is “equipment absent” and does not support the process-command as the request. The same applies to other vehicles such as “Vehicle B” and “Vehicle C.” The information on paid support (corresponding to support information) refers to information that enables to specify whether or not the process-target ECU supports the process-command as the request. The “paid function present” indicates a service that involves payment and requires payment. If the payment is completed, it indicates that the process-command as the request is supported, and if the payment is not completed, it indicates that the process-command as the request is not supported. The “paid function absent” indicates a service that does not involve payment, i.e., the process-command as the request is supported without requiring the payment.

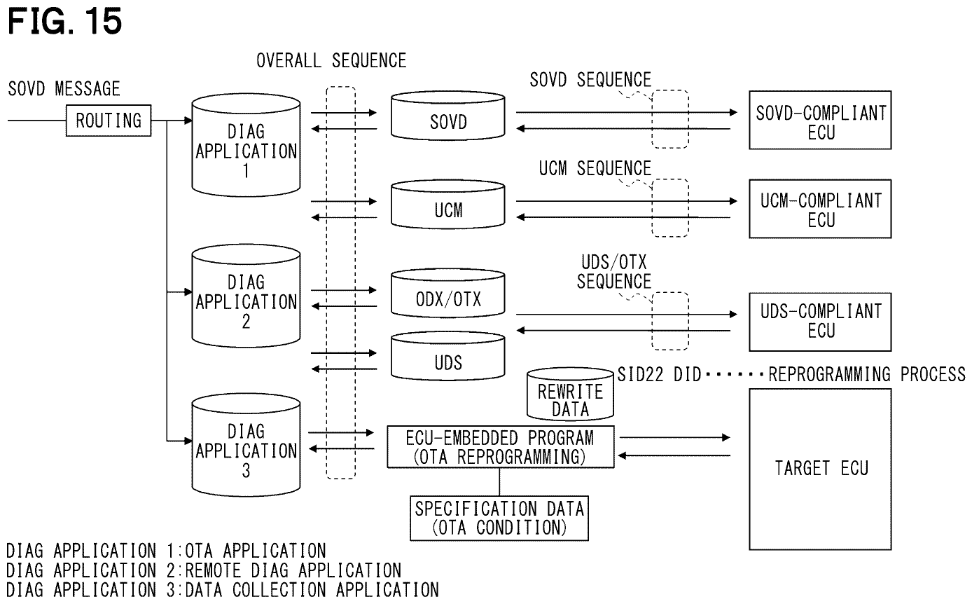

The process-target specifier table shown in FIG. 13 above illustrates a case where the OTA application is specified by a path in an SOVD format message. If a remote diagnostic application or a data collection application is specified by a path in an SOVD format message, the remote diagnostic application or the data collection application may process the SOVD format message by using the same process-target specifier table. As shown in FIG. 15, the routing of the SOVD message within the vehicle may be performed according to the path (PATH) included in the SOVD format message. If the control unit 6 retains the OTA application (corresponding to the OTA master 8 shown in FIG. 1) as a diagnostic application 1, the remote diagnostic application as a diagnostic application 2, and the data collection application as a diagnostic application 3, the downloader 7 (the routing block shown in FIG. 13) interprets for which application the SOVD format message is destined and forwards it to the appropriate diagnostic application. If the downloader 7 specifies that the SOVD message is destined for the OTA application, the downloader 7 forwards the SOVD message to the diagnostic application 1. If the downloader 7 specifies that the SOVD message is destined for the remote diagnostic application, the downloader 7 forwards the SOVD message to the diagnostic application 2. If the downloader 7 specifies that the SOVD message is destined for the data collection application, the downloader 7 forwards the SOVD message to the diagnostic application 3.

The process-command receiver unit 32 accepts the process-command based on the SOVD format message or file from the OTA center 2. When the process-command based on the SOVD format message or file from the OTA center 2 is accepted by the process-command receiver unit 32, the process-target specifier unit 33 refers to the process-target specifier table retained in the process-target specifier table retention unit 31 and specifies the connection destination, the process method, the service, the function support, and the paid support that correspond to the accepted process-command of the SOVD format.

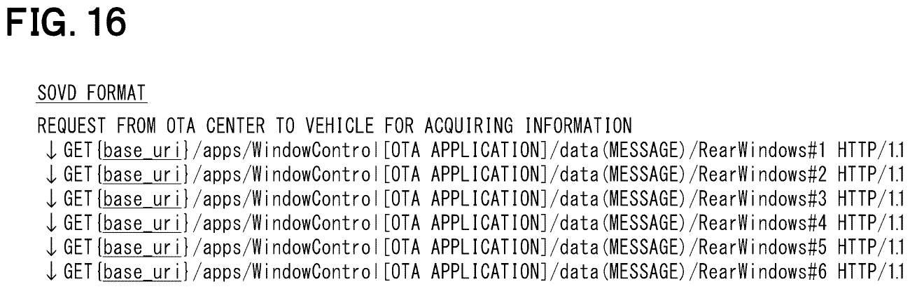

As shown in FIG. 16, when the process-command based on the SOVD format message

### GET{base_uri}/apps/WindowControl[OTAapp]/data(message)/RearWindows#1 HTTP/1.1

is received as the request from the OTA center 2 to the vehicle for acquiring information, the process-target specifier unit 33 refers to the process-target specifier table shown in FIG. 13 to search for

### GET{base_uri}/apps/WindowControl[OTAapp]/data(message)/RearWindows#1 HTTP/1.1.

Since the above process-command is stored, the process-target specifier unit 33 specifies the information on the connection destination, the process method, the service, the function support, and the paid support that correspond to this process-command. In the example shown in FIG. 13, the process-target specifier unit 33 specifies that the connection destination, the process method, and the service, respectively, are “body system bus, door ECU, Eth communication, IP address”, “OTA master collection method”, and ““SID22 DID****” as corresponding to

### GET{base_uri}/apps/WindowControl[OTAapp]/data(message)/RearWindows#1 HTTP/1.1.

For example, the process-target specifier unit 33 specifies that the process-command as the request is supported in the process-target ECU if it is in the high grade of the vehicle A and the payment is completed. If it is in the high grade of the vehicle A and the payment is not completed, the process-target specifier unit 33 specifies that the process-command as the request is not supported in the process-target ECU. If, for example, it is in the low grade of the vehicle A, the process-target specifier unit 33 specifies that the process-command as the request is not supported in the process-target ECU. In addition, when the process-command based on the SOVD format message

### GET{base_uri}/apps/WindowControl[OTAapp]/data(message)/RearWindows#1 HTTP/1.1

is received, the process-target specifier unit 33 refers to the process-target specifier table shown in FIG. 13 and specifies that the connection destination is “powertrain system bus, window ECU, Eth communication, IP address” and the collection method is “OTA master collection method” and the service is “SID22 DID++++”.

The process-target specifier unit 33 specifies that the process-command as the request is supported in the process-target ECU if, for example, it is in the high grade of vehicle C and the payment is completed. If, for example, it is in the high grade of the vehicle C and the payment is not completed, the process-target specifier unit 33 specifies that the process-command as the request is not supported in the process-target ECU. If, for example, it is in the low grade of the vehicle C, the process-target specifier unit 33 specifies that the process-command as the request is not supported in the process-target ECU.

In addition, when the process-command based on the SOVD format message

### GET{base_uri}/apps/WindowControl[OTAapp]/data(message)/RearWindows#6 HTTP/1.1

is received as the request from the OTA center 2 to the vehicle for acquiring information, the process-target specifier unit 33 refers to the process-target specifier table shown in FIG. 13 to search for

### GET{base_uri}/apps/WindowControl[OTAapp]/data(message)/RearWindows#6 HTTP/1.1.

Since the above process-command is not stored, the process-target specifier unit 33 unsuccessfully specifies the information on the connection destination, the process method, the service, the function support, and the paid support that correspond to this process-command.

In addition, when the process-command based on the SOVD format message

### GET{base_uri}/apps/WindowControl[OTAapp]/data(message)/RearWindows#8 HTTP/1.1

is received as the request from the OTA center 2 to the vehicle for acquiring information, the process-target specifier unit 33 refers to the process-target specifier table shown in FIG. 13 to search for

### GET{base_uri}/apps/WindowControl[OTAapp]/data(message)/RearWindows#8 HTTP/1.1.

Since the above process-command is stored but there is no records of the information on the process-target, the connection destination, the process method, the service, the function support, and the payment support that correspond to this process-command, the process-target specifier unit 33 unsuccessfully specifies the information on the connection destination, the process method, the service, the function support, and the payment support that correspond to this process-command.

When the process-target specifier unit 33 unsuccessfully specifies the process-target ECU, the specifying-unsuccessful information transmitter unit 34 causes the DCM 4 to transmit specifying-unsuccessful information to the OTA center 2 indicating that the process-target ECU has unsuccessfully been specified.

When the process-target ECU is successfully specified by the process-target specifier unit 33 but it is specified by the process-target specifier unit 33 that the process-command is not supported in this process-target ECU, the unsupported information transmitter unit 35 causes the DCM 4 to transmit unsupported information to the OTA center 2 indicating that the process-command is not supported in this process-target ECU.

When the process-target ECU is successfully specified by the process-target specifier unit 33 and it is specified by the process-target specifier unit 33 that the process-command is supported in this process-target ECU but this process-target ECU has not responded to the process-command as the request, the no-response information transmitter unit 36 causes the DCM 4 to transmit no-response information to the OTA center 2 indicating that the process-target ECU has not responded to the process-command as the request.

The update request transmitter unit 37 causes the DCM 4 to transmit an update request for the process-target specifier table to the OTA center 2 in order to update the process-target specifier table. In this case, the update request transmitter unit 37 causes the DCM 4 to transmit, to the OTA center 2, information that enables to identify the process-target specifier table currently retained in the process-target specifier table retention unit 31. The information that enables to identify the process-target specifier table is, for example, version information indicating an old or new version of the process-target specifier table, or the like. The update request transmitter unit 37 causes the DCM 4 to transmit the update request for the process-target specifier table to the OTA center 2 when the process-target specifier unit 33 failed to specify the process-target EC as described above. Also, in addition to the case where the process-target specifier unit 33 failed to specify the process-target ECU, the update request transmitter unit 37 periodically determines whether or not an update on the process-target specifier table is present in the OTA center 2, and upon determining that the update on the process-target specifier table is present, the update request transmitter unit 37 causes the DCM 4 to transmit the update request for the process-target specifier table to the OTA center 2.

The process-target specifier table delivered from the OTA center 2 is received by the DCM 4 and forwarded from the DCM 4, so that the process-target specifier table acquirer unit 38 acquires the process-target specifier table. When the process-target specifier table is acquired by the process-target specifier table acquirer unit 38, the updater unit 39 updates the process-target specifier table retained in the process-target specifier table retention unit 31 with the acquired process-target specifier table. That is, by updating with the process-target specifier table, the updating unit 39 synchronizes the process-target specifier table in the vehicle with the process-target specifier table retained in the OTA center 2.

The timing to update the process-target specifier table includes timing of synchronizing individual vehicle configuration information between the OTA master 8 and the OTA center 2, timing of the OTA master 8 acquiring HMI data from the OTA center 2, timing of the OTA master 8 confirming the validity of the campaign information notified by the OTA center 2, timing of transmitting a state notification or a completion notification to the OTA center 2, timing of software version upgrade, etc. The timing may be timing of turn on of a battery power, timing of turn on of an ignition switch or a motor switch, timing of HMI operation, etc.

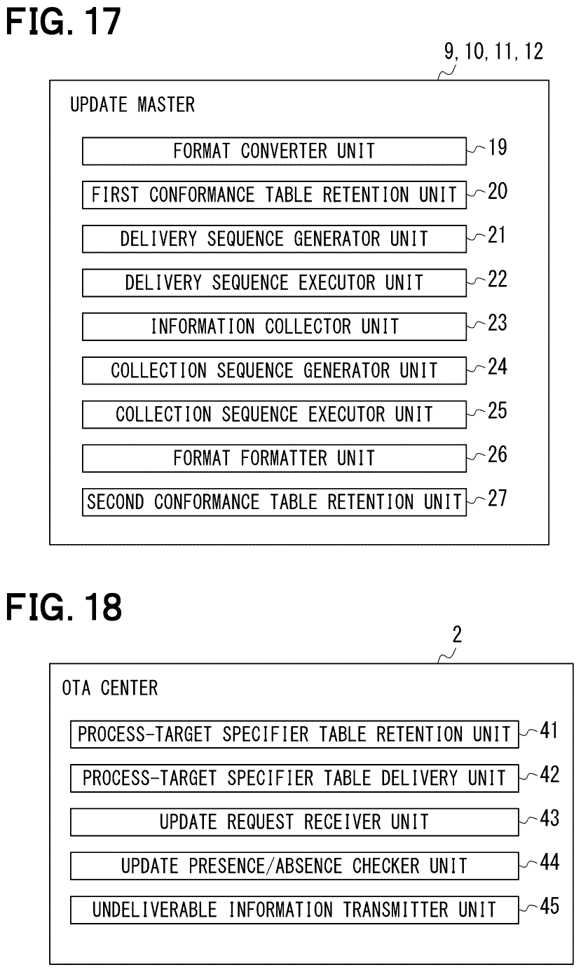

As shown in FIG. 17, on a function basis, the update master 9 to 12 includes a format converter unit 19, a first conformance table retention unit 20, a delivery sequence generator unit 21, a delivery sequence executor unit 22, an information collector unit 23, a collection sequence generator unit 24, a collection sequence executor unit 25, a format formatter unit 26 and a second conformance table retention unit 27. Respective units 19 to 27 are the same as those in the first embodiment.

If the update master 9 to 12 fails to convert the format at the format converter unit 19, or fails to generate the delivery sequence at the delivery sequence generator unit 21, or fails to execute the delivery sequence at the delivery sequence executor unit 22, the update master 9 to 12 causes the DCM 4 to transmit error information indicating this to the OTA center 2 and requests the OTA center 2 for, for example, the latest conversion map for format conversion, the latest sequence generation map for generating the delivery sequence, the latest software for executing the delivery sequence, etc. If the update master 9 to 12 fails to generate the collection sequence at the collection sequence generator unit 24, fails to execute the collection sequence at the collection sequence executor unit 25, or fails to form the format at the format formatter unit 26, the update master 9 to 12 causes the DCM 4 to transmit error information indicating this to the OTA center 2 and requests the OTA center 2 for, for example, the latest sequence generation map for generating the collection sequence, etc.

Next, the OTA center 2 will be described. As shown in FIG. 18, on a functional basis, the OTA center 2 includes a process-target specifier table retention unit 41 (corresponding to a vehicle-external side specifier information retention unit), a process-target specifier table delivery unit 42, an update request receiver unit 43, an update presence/absence checker unit 44, and an undeliverable information transmitter unit 45.

The process-target specifier table retention unit 41 retains the process-target specifier table, like the process-target specifier table retention unit 31 in the OTA master 8 described above. The process-target specifier table delivery unit 42 delivers the process-target specifier table retained in the process-target specifier table retention unit 41 to the vehicular system 3.

The update request receiver unit 43 receives the update request transmitted from the vehicular system 3 for the process-target specifier table. When the update request transmitted from the vehicular system 3 for the process-target specifier table is received by the update request receiver unit 43, the process-target specifier table delivery unit 42 determines whether or not to deliver the process-target specifier table to the vehicular system 3 based on configuration information included in the received update request for the process-target specifier table. That is, the table delivery unit 42 compares between the target-specified tables retained in the OTA center 2 and the target-specified table retained in the vehicular system 3 with respect to new and old based on the configuration information included in the update request for the process-target specifier table. If the process-target specifier table retained in the OTA center 2 is newer than the process-target specifier table retained in the vehicular system 3, the process-target specifier table delivery unit 42 delivers the process-target specifier table to the vehicular system 3.

In addition, the update presence/absence checker unit 44 determines whether the update on the process-target specifier table retained in the process-target specifier table retention unit 41 is present or absent. The process-target specifier table delivery unit 42 determines whether or not to deliver the process-target specifier table to the vehicular system 3 based on whether or not the update on the process-target specifier table retained in the process-target specifier table retention unit 41 is present. The process-target specifier table delivery unit 42 delivers the process-target specifier table to the vehicular system 3 when the process-target specifier table retained in the process-target specifier table retention unit 41 is updated.

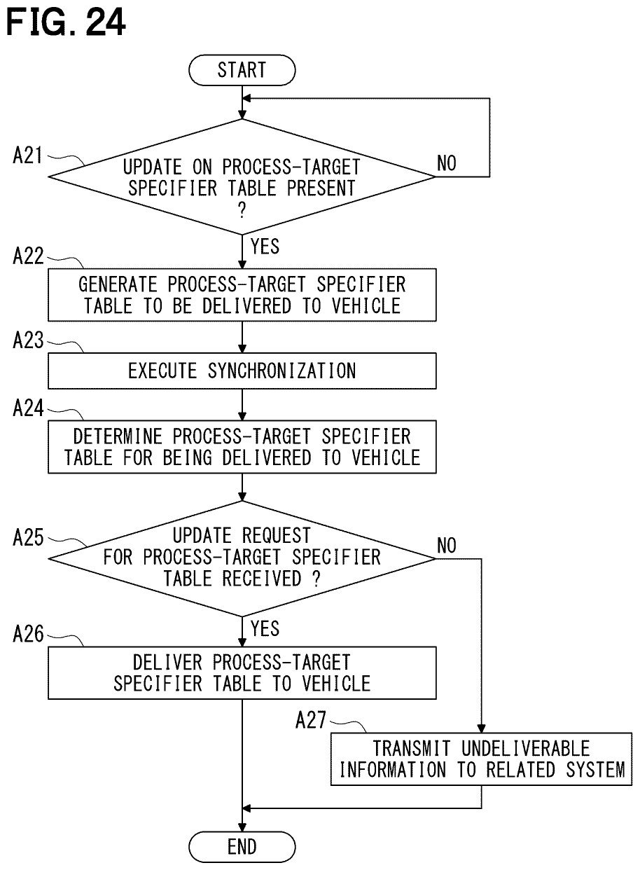

The update presence/absence checker unit 44 determines that the update on the process-target specifier table is present in the following cases, for example. When a new grade is released for an existing vehicle type of a certain OEM, a function of the existing vehicle class of the certain OEM becomes able to be activated upon payment, or a function of the existing vehicle class of the certain OEM becomes able to be activated as a user option without payment, the update presence/absence checker unit 44 determines that the update on the process-target specifier tabled is present (corresponding to “YES” in step A21 of FIG. 24 described below). After that, the process-target specifier table is generated at the OTA center 2 (corresponding to step A22 in FIG. 24, described below). Generation of the updated process-target specifier table may be performed via receiving a file from the OEM or the like and adding those in the file to the existing process-target specifier table, wherein the file includes description of: a process-command to be added to the process-target specifier table because a new function becomes able to be activated for example; and the connection destination, the process method, the service, the function support, and the paid support that correspond to this process-command.

When the process-target specifier table is undeliverable to the vehicular system 3 by the process-target specifier table delivery unit 42, the undeliverable information transmitter unit 45 transmits undeliverable information to a related system indicating the process-target specifier table is undeliverable. Examples of the related system include a system that manages the SOVD services and are not limited to the OTA center 2 but include a log collection center that collects logs and a remote diagnostic center that performs remote diagnostics.

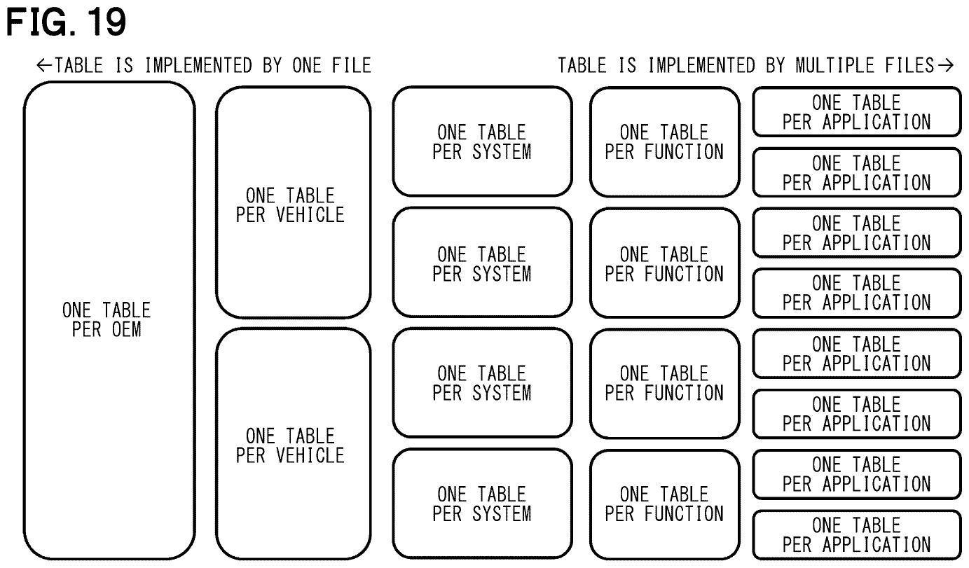

In the above configuration, the process-target specifier tables may be provided in various units, as shown in FIG. 19. For example, the tables may be provided in units of OEM (Original Equipment Manufacturing), vehicle, system, function, application, etc. For example, when the tables are provided in units of OEM or vehicle, a data volume of a respective table is relatively large, and an update frequency is relatively high but the number of tables to be managed is advantageously relatively small. On the other hand, when the tables are provided in units of application or function for example, the number of tables to be managed is relatively large but a data volume of a respective table is advantageously relatively small, and an update frequency is advantageously relatively low.

For example, let us assume a case in which a function becomes able to be activated upon payment in a certain grade of a certain OEM vehicle type. In this case, if the process-target specifier tables are provided in units of OEM, the process-target specifier tables used by all vehicles of that OEM may be updated. If the process-specifier tables are provided in units of vehicle, the process-specifier tables used by, among the vehicles of that OEM, vehicles of a corresponding grade of a corresponding vehicle type may be updated, but the process-specifier tables used by vehicles other than the vehicles of the corresponding grade of the corresponding vehicle type may not be updated.

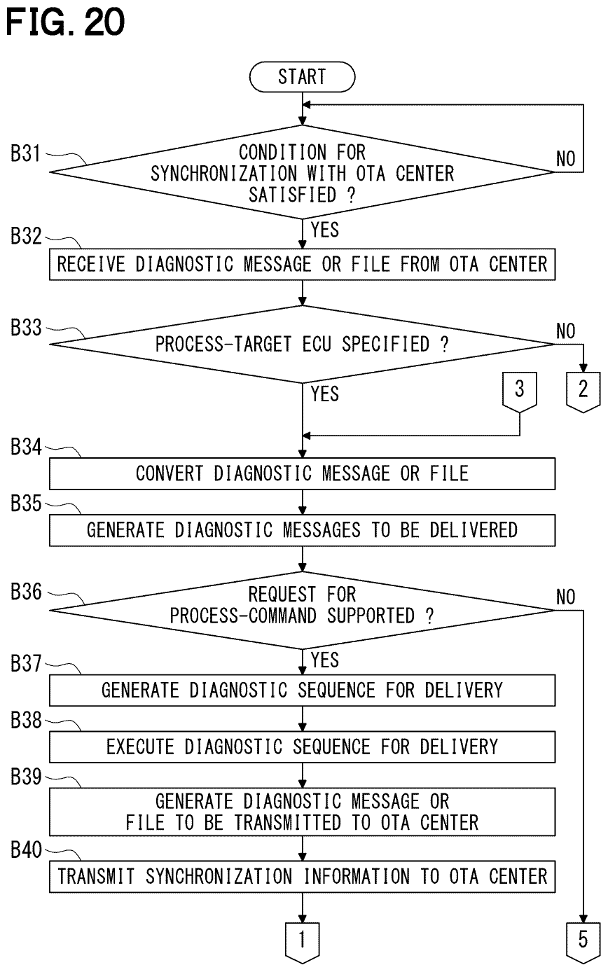

Next, the operation of the above-described configuration will be described with reference to FIG. 20 to FIG. 24. A vehicle-side process performed by the CGW 4 and a center-side process performed by the OTA center 2 will be described in turn.

### (1) Vehicle-side Process Performed by CGW 4 (see FIG. 20 to FIG. 23).

In the CGW 4, upon start of the vehicle-side process, the control unit 6 determines whether or not a condition for synchronization with the OTA center 2 is satisfied (B31). Upon determining that the condition for synchronization with the OTA center 2 is satisfied (B31: YES) and receiving the diagnostic message or file in the SOVD format from the OTA center 2 (B32, corresponding to a process-command receiving procedure), the control unit 6 refers to the process-target specifier table described above. The control unit 6 searches the received diagnostic message or file in the SOVD format and determines whether or not the process-target ECU corresponding to the diagnostic message or file in the SOVD format has been specified using the process-target specifier table (B33).

Upon determining that the process-command corresponding to the received diagnostic message or file in the SOVD format is stored in the process-target specifier table and the process-target ECU corresponding to the diagnostic message or file in the SOVD format has been specified (B33: YES, corresponding to a process-target specifying procedure), the control unit 6 converts the received diagnostic message or file (B34).

The control unit 6 performs the format conversion described above, generates the diagnostic messages to be delivered to the diagnosis target ECU (B35), and determines whether or not the process-command as the request is supported, based on the function support and the paid support (B36). Upon determining that the process-command as the request is supported (B36: YES), the control unit 6 generates the diagnostic sequence for delivery to the diagnostic target ECU (B37), executes the generated diagnostic sequence (B38) to communicate with the diagnosis target ECU. The control unit 6 generates the diagnostic message or file to be transmitted to the OTA center 2 (B39) and transmits the synchronization information to the OTA center 2 (B40).

The control unit 6 determines whether or not a command from the OTA center 2 to execute the diagnostic service is present (B41). When it is determined that the command from the OTA center 2 to execute the diagnostic service is present (B41: YES) and the diagnostic message or file from the OTA center 2 is received (B42, corresponding to a process-command acceptance procedure), the control unit 6 refers to the process-target specifier table described above. The control unit 6 searches the received diagnostic message or file in the SOVD format and determines whether or not the process-target ECU corresponding to the received diagnostic message or file in the SOVD format has been specified using the process-target specifier table (B43).

Upon determining that the process-command corresponding to the received diagnostic message or file in the SOVD format is stored in the process-target specifier table and that the process-target ECU has been specified (B43: YES, corresponding to a process-target specifying procedure), the control unit 6 converts the received diagnostic message or file (B44).

The control unit 6 performs the format conversion described above, generates diagnostic messages to be delivered to the diagnosis target ECU (B45), and determines whether the process-command as the request is supported, based on the function support and the paid support (B46). Upon determining that the process-command as the request is supported (B46: YES), the control unit 6 generates the diagnostic sequence for delivery to the diagnosis target ECU (B47), executes the generated diagnostic sequence to communicate with the diagnosis target ECU (B48). To the OTA center 2, the control unit 6 transmits the state and result of the diagnostic sequence for delivery to the diagnosis target ECU (B49) and ends the vehicle side process.

On the other hand, upon determining that the process-command corresponding to the received diagnostic message or file in the SOVD format is not stored in the process-target specifier table and that the process-target ECU is unsuccessfully specified (B33: NO), the control unit 6 transmits the update request for the process-target specifier table to the OTA center 2 (B50) and waits to receive the process-target specifier table from the OTA center 2 (B51). Upon determining that the process-target specifier table delivered from the OTA center 2 has been received (B51: YES), the control unit 6 determines whether or not the process-target specifier table retained at that time has been updated with the received latest process-target specifier table (B52).

Upon determining that the process-target specifier table has been updated (B52: YES), the control unit 6 moves to step B34. That is, the control unit 6 performs step B34 and subsequent steps based on the updated process-target specifier table. On the other hand, upon determining that the process-target specifier table has not been updated (B52: NO), the control unit 6 transmits a not-update notification to the OTA center 2 indicating that the process-target specifier table has not been updated (B53) and ends the vehicle side process.

Upon determining that the diagnostic service execution command from the OTA center 2 is present (B41: YES) and thereafter determining that the process-target ECU is unsuccessfully specified (B43: NO), the control unit 6 in this case also executes the same steps as steps B50 to B53 described above. That is, the control unit 6 transmits the update request for the process-target specifier table to the OTA center 2 (B54) and waits to receive the process-target specifier table from the OTA center 2 (B55). Upon determining that the process-target specifier table delivered from the OTA center 2 has been received (B55: YES), the control unit 6 determines whether or not the process-target specifier table retained at that time has been updated with the received latest process-target specifier table (B56).

Upon determining that the process-target specifier table has been updated (B56: YES), the control unit 6 moves to step B44. That is, the control unit 6 performs step B44 and subsequent steps based on the updated process-target specifier table. On the other hand, upon determining that the process-target specifier table has not been updated (B56: NO), the control unit 6 transmits the not-update notification to the OTA center 2 indicating that the process-target specifier table has not been updated (B57) and ends the vehicle side process.

Upon determining based on the function support and the paid support that the process-command as the request is not supported (B36: NO, B46: NO), the control unit 6 refrains from transmitting messages to the process-target ECU (B58) and ends the vehicle-side process.

(2) Center-side Process performed by OTA Center 2 (see FIG. 24).

Upon start of the center-side process, the OTA center 2 determines whether or not the update on the process-target specifier table is present (A21). Upon determining that the update on the process-target specifier table is present (A21: YES), the OTA center 2 generates the process-target specifier table to be delivered to the vehicle (A22) and executes the synchronization with the vehicle (A23).

After executing the synchronization with the vehicle, the OTA center 2 determines the process-target specifier table for being delivered to the vehicle (A24) and determines whether the update request for the process-target specifier table has been received (A25). Upon determining that the update request for the delivered process-target specifier table has been received from the vehicular system 3 (A25: YES), the OTA center 2 delivers the process-target specifier table to the vehicular system 3 (A26, corresponding to a specifier information delivery procedure), and ends the center-side process. On the other hand, upon determining that the update request for the process-target specifier table has not been received (A26: NO), the OTA center 2 transmits the undeliverable information to the related system indicating that the process-target specifier table is undeliverable to the vehicular system 3 (A27) and ends the center-side process.

The above-described second embodiment provides following operational effects. The CGW 4 retains the process-command based on the message or file in the SOVD format conforming to the SOVD communication specifications and the process-target specifier table which enables to specify the process-target ECU that corresponds to the process-command. When the process-command based on the message or file in the SOVD format is accepted, the process-target specifier table is referred to and the process-target ECU corresponding to the accepted process-command is specified based on the connection destination information. It is possible to appropriately specify the process-target ECU that corresponds to the accepted process-command, and it is possible to appropriately achieve the SOVD service when the process-command based on the message or file in the SOVD format conforming to the SOVD communication specifications is accepted.

When the process-command based on the message or file in the SOVD format is accepted, the process-target specifier table is referred to and the process method corresponding to the accepted process-command is specified based on the process method information. It is possible to appropriately specify the process method corresponding to the accepted process-command in addition to appropriately specifying the process-target ECU corresponding to the accepted process-command,

When the process-target ECU is unsuccessfully specified, the specifying-unsuccessful information indicating that the process-target ECU is unsuccessfully specified is transmitted to the OTA center 2. It is possible to notify the OTA center 2 that the process-target ECU is unsuccessfully specified.

When the process-command based on the message or file in the SOVD format is accepted, it is specified based on the support information whether or not the accepted process-command as the request is supported based on the support information with reference to the process-target specifier table. In addition to appropriately specifying the process-target ECU corresponding to the accepted process-command, it is also possible to appropriately specify whether or not the accepted process-command as the request is supported.

When the accepted process-command as the request is not supported, the unsupported information indicating that the accepted process-command as the request is not supported in the process-target ECU is transmitted to the OTA center 2. It is possible to notify the OTA center 2 that the accepted process-command as the request is not supported in the process-target ECU.

When the process-target ECU has not responded to the process-command as the request, the no-response information indicating that the target ECU has not responded to the process-command as the request is transmitted to the OTA center 2. It is possible to notify the OTA center 2 that the process-target ECU has not responded to the process-command as the request.

When the process-target ECU corresponding to the accepted process-command is unsuccessfully specified based on the connection destination information, an update request for updating the process-target specifier table is transmitted to the OTA center 2. From the OTA center 2, it is possible to acquire the latest process-target specifier table retained in the OTA center 2.

When it is specified that the update on the process-target specifier table in the OTA center 2 is present, the update request for updating the process-target specifier table is transmitted to the OTA center 2. In this case also, from the OTA center 2, it is possible to acquire the latest process-target specifier table retained in OTA center 2.

The process-target specifier table retained in the process-target specifier table retention unit 31 is updated with the process-target specifier table acquired from the OTA center 2. It is possible to synchronize the process-target specifier table retained in the vehicular system 3 with the process-target specifier table retained in the OTA center 2, and it is possible to retain the latest process-target specifier table in the vehicular system 3.

The OTA center 2 delivers the process-target specifier table retained in the process-target specifier table retention unit 41 to the vehicular system 3. It is possible to synchronize the process-target specifier table retained in the vehicular system 3 with the process-target specifier table retained in the OTA center 2, and it is possible to retain the latest process-target specifier table in the vehicular system 3.

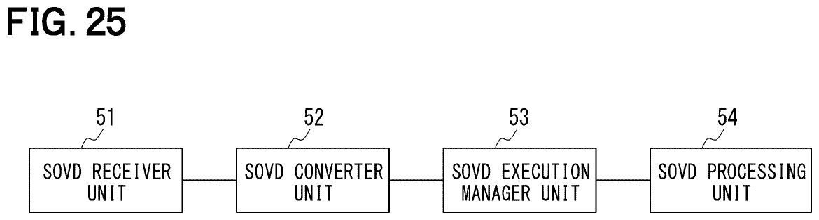

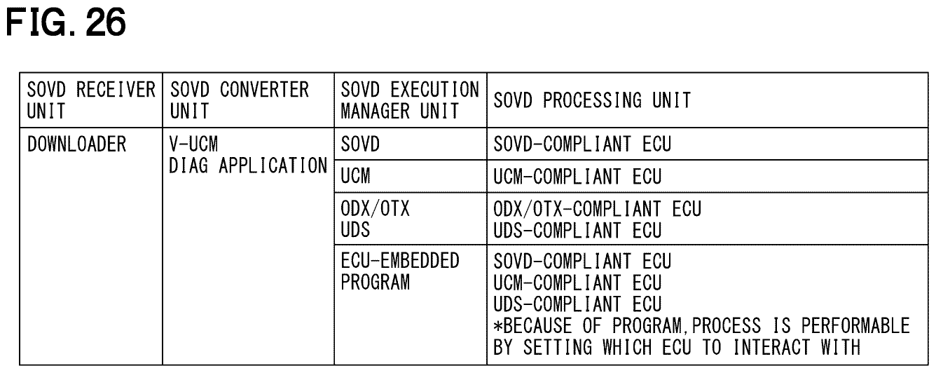

Description supplement for the above will be given with reference to FIG. 25 to FIG. 32. FIG. 25 and FIG. 26 show respective functions provided in the vehicle. The SOVD receiver unit 51 corresponds, for example, to the downloader 7 described in FIG. 1 and FIG. 11. The SOVD converter unit 52 corresponds, for example, to a V-UCM and the diagnostic application described in FIG. 14 and FIG. 15. The SOVD execution manager unit 53 corresponds, for example, to the SOVD, UCM, ODX/OTX, UDS, and ECU-embedded program described in FIG. 14 and FIG. 15. The SOVD processing unit 54 corresponds, for example, to the SOVD-compliant ECU 15, UCM-compliant ECU 14, ODX/OTX-compliant ECU 17, and UDS-compliant ECU 16 described in FIG. 1 and FIG. 11.

The SOVD receiver unit 51 receives the message or file based on the SOVD format from the OTA center 2, interprets the SOVD format of the received message or file, and outputs an execution command to the SOVD converter unit 52. The SOVD converter unit 52 accepts the execution command from the SOVD receiver unit 51 and outputs the process-command to the SOVD execution manager unit 53 arranged as a subordinate of the SOVD converter unit 52. The SOVD execution manager unit 53 specifies the service to be transmitted, based on the process-target specifier table shown in FIG. 13 above. When the service to be transmitted is specified by the SOVD execution manager unit 53, the SOVD processing unit 54 performs processes based on the specified service.

The SOVD receiver unit 51, the SOVD converter unit 52 and the SOVD execution manager unit 53 may be arranged in the same single CGW 4 or in separate CGWs 4. Upon specifying the service to be transmitted, the SOVD execution manager unit 53 prepares to transmit the message to the SOVD processing unit 54. If the SOVD execution manager unit 53 unsuccessfully specifies the service to be transmitted and has downloaded the program to be executed, the SOVD execution manager unit 53 prepares to transmit the message to the SOVD processing unit 54 by executing the program.

After preparing to transmit the message to the SOVD processing unit 54, the SOVD execution manager unit 53 transmits the message to the SOVD process unit 54, thereby accessing the target information and performing processes. The SOVD execution manager unit 53 determines whether an additional process is necessary based on a response from the SOVD processing unit 53, and upon determining that the additional process is necessary, the SOVD execution manager unit 53 requests the SOVD processing unit 54 for an additional process-command.

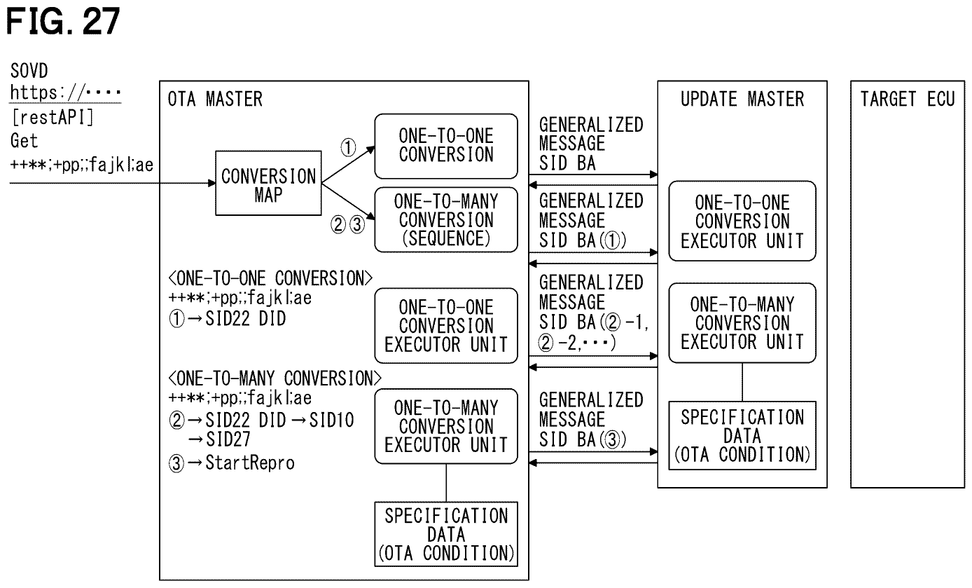

Next, an overview of SOVD will be provided with reference to FIG. 27 to FIG. 32.

As shown in FIG. 27, the OTA master 8 includes the conversion map for converting SOVD messages. When the SOVD message is, for example, “https:// . . . [restAPI]Get++**;+pp;;fajkl;ae”, the OTA master 8 converts “++**; +pp;;fajkl;ae” by one-to-one conversion or by one-to-many conversion in accordance with the conversion map. In the case of the one-to-many conversion, the OTA master 8 generates a sequence that includes the order in which multiple post-conversion messages are transmitted. The update master 9 to 12 converts the generalized messages. The update master 9 to 12 converts the generalized message by one-to-one conversion or by one-to-many conversion according to the conversion map, for example. In the case of the one-to-many conversion, the update master 9 to 12 generates the sequence that includes the order in which multiple post-conversion messages are transmitted. As mentioned above, a sequence may be generated by arranging the default sequence according to the contents of the specification data.

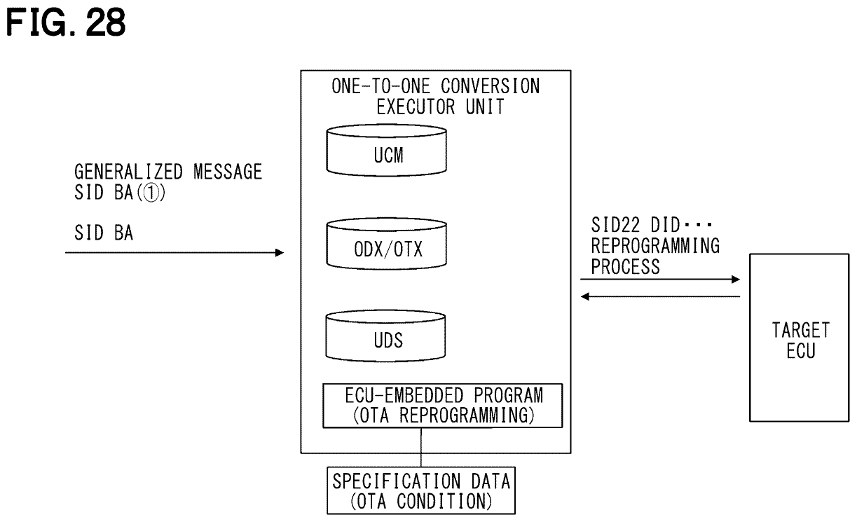

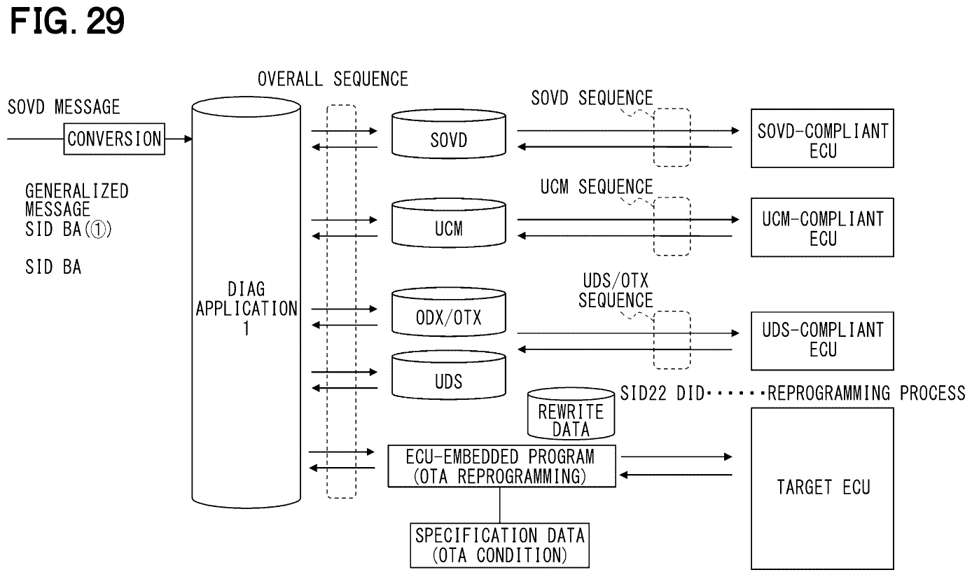

As shown in FIG. 28, when the conversion is performed according to the one-to-one conversion, the update master 9 to 12 converts “+++**;+pp;;fajkl;ae” to, for example, “SID22 DID” by the one-to-one conversion. When the OTA master 8 performs the one-to-many conversion and a respective update master 9 to 12 performs the one-to-many conversion, as shown in FIG. 29, the OTA master 8 may perform the sequence to communication with multiple update masters 9 to 12 and the respective update master 9 to 12 may perform the sequence to communicate with multiple target ECUs. The communication sequence between the OTA master 8 and the multiple update masters 9 to 12 may include the order in which the generalized messages are transmitted to the multiple update masters 9 to 12. The communication sequence between one update master and multiple target ECUs may include the order in which messages are transmitted to the multiple target ECUs.

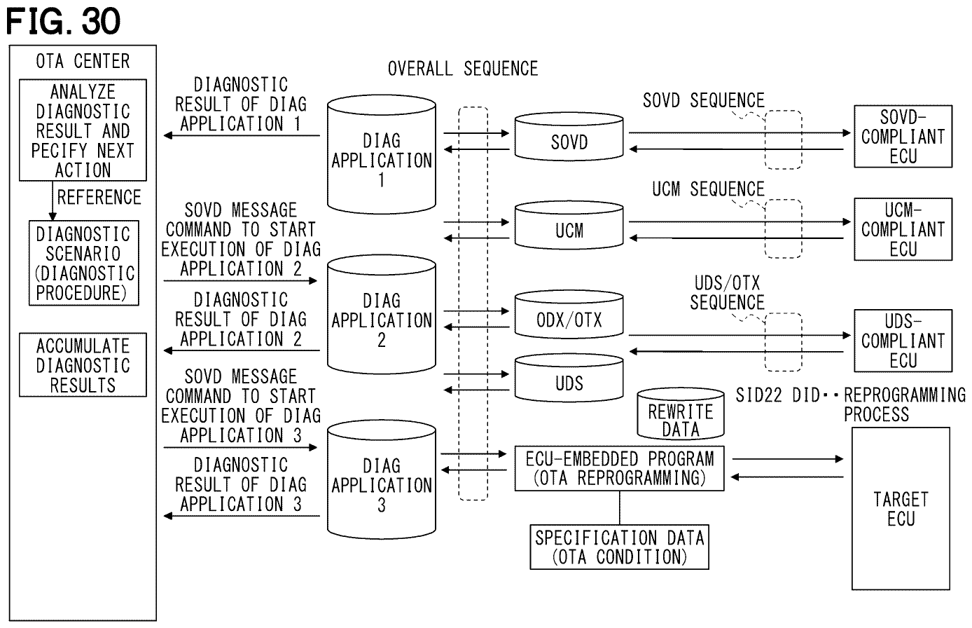

As shown in FIG. 30, the OTA center 2 has a function of, upon receipt of the diagnostic result from the vehicular system 5, executing a diagnostic sequence to analyze the received diagnostic result and specify a next action according to a diagnostic procedure, and has a function of accumulating the diagnostic results. The OTA center 2 performs the diagnostic sequence according to the diagnostic procedure. The diagnostic sequence includes a sequence of transmission of SOVD format messages from the OTA center 2 to the vehicular system 5 for sequential execution of multiple diagnostic applications. The vehicular system 5 selects one or more of the multiple diagnostic applications according to the identification information acquired from the OTA center 2. In detail, the downloader 7 forwards the SOVD format-based message to one or more of the multiple diagnostic applications according to the path included in the SOVD format message, and the diagnostic application that receives the message executes the diagnostic process according to contents of the message.

When the OTA center 2 receives a result of periodic diagnosis by a periodic diagnostic application which is an example of a diagnostic result of the diagnostic application 1 from the vehicular system 5, the OTA center 2 analyzes the periodic diagnostic result. If the OTA center 2 obtains an analysis result that, in the diagnostic procedure, is associated with necessity of detailed diagnostics, the OTA center 2 specifies that the next action is to execute the detailed diagnostics, which is associated with the necessity of the detailed diagnostics in the diagnostic procedure. In this case, OTA center 2 transmits, for example, a command to execute the detailed diagnostics to the vehicular system 5 as an execution start command for the diagnostic application 2. When the vehicular system 5 receives the execution start command for the diagnostic application 2 from the OTA center 2, the vehicular system 5 executes the detailed diagnostics, for example, by the diagnostic application 2 and transmits a diagnostic result of the diagnostic application 2 to the OTA center 2.

When the OTA center 2 receives the diagnostic result of the diagnostic application 2 from the vehicular system 5, the OTA center 2 analyzes the detailed diagnostics result. When the OTA center 2 obtains an analysis result that, in the diagnostic procedure, is associated with necessity of cause-identifying diagnostics, the OTA center 2 specifies that the next action is to execute the cause-identifying diagnostics, which is associated with the necessity of the cause-identifying diagnostics in the diagnostic procedure. In this case, the OTA center 2 transmits, for example, a command to execute the cause-identifying diagnostics to the vehicular system 5 as an execution start command for the diagnostic application 3. When the vehicular system 5 receives the execution start command for the diagnostic application 3 from the OTA center 3, the vehicular system 5 executes, for example, the cause-identifying diagnostics by the diagnostic application 3 and transmits a diagnostic result of the diagnostic application 3 to the OTA center 2.

When the OTA center 2 receives the diagnostic result of the diagnostic application 3 from the vehicular system 5, the OTA center 2 analyzes the cause-identifying diagnostics result. If an abnormality of software is identified for example, the OTA center specifies that the next action is an update on the software that, in the diagnostic procedure, is associated with the abnormality and transmits software update data to the vehicular system 5 and commands a software update via the SOVD message.

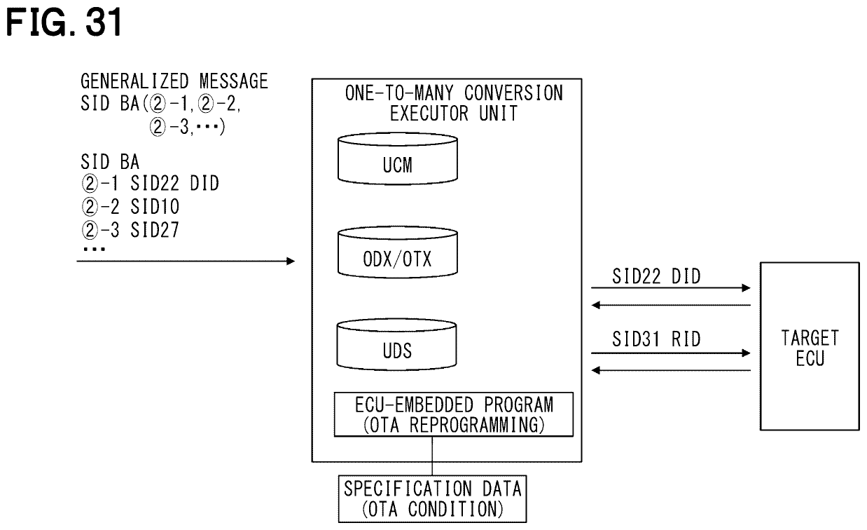

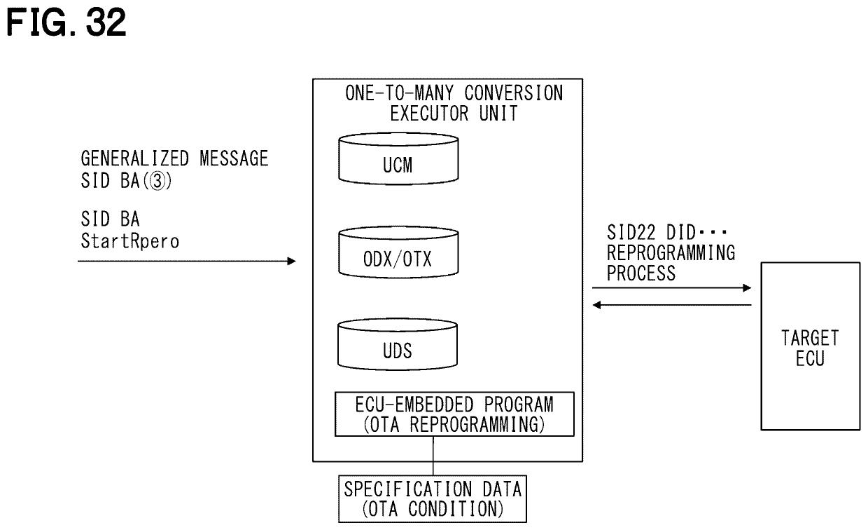

As shown in FIG. 31 and FIG. 32, in the case of converting by the one-to-many conversion, “+++**;+pp;; fajkl;ae” is converted to “SID22 DID, SID10, SID27, . . . ” or “StartRepro” for example in the one-to-many conversion.

The present disclosure encompasses the following in addition to what is claimed.

<1> A vehicular system (3) that acquires a message or a file in an SOVD format compliant with SOVD communication specifications includes:
a vehicle-side specifier information retention unit (31) that retains process-target specifier information indicating association between a process-command based on the message or the file in the SOVD format and connection destination information enabling to specify a process-target corresponding to the process-command;
a process-command receiver unit (32) that accepts the process-command; and
a process-target specifier unit (33) that, when the process-command is accepted by the process-command receiver unit, refers to the process-target specifier information and specifies the process-target corresponding to the accepted process-command based on the connection destination information.

<2> In the vehicular system according to <1>:
in addition to the connection destination information, the process-target specifier information further includes process method information enabling to specify a process method corresponding to the process-target; and
when the process-command is accepted by the process-command receiver unit, the process-target specifier unit refers to the process-target specifier information and specifies the process-target corresponding to the accepted process-command based on the connection destination information and further specifies the process method corresponding to the process-target based on the process method information.

<3> The vehicular system according to <1> or <2>further incudes:
a specifying-unsuccessful information transmitter unit (34) that, when the process-target is unsuccessfully specified by the process-target specifier unit, transmits specifying-unsuccessful information to a vehicle-external device indicating that specifying the process-target is unsuccessful.

<4> In the vehicular system according to any one of <1> to <3>:
in addition to the connection destination information, the process-target specifier information further includes support information enabling to specify whether or not the process-command as a request is supported in the process-target; and
when the process-command is accepted by the process-command receiver unit, the process-target specifier unit refers to the process-target specifier information and specifies the process-target corresponding to the accepted process-command based on the connection destination information and further specifies based on the support information whether or not the process-command as the request is supported in the process-target.

<5> The vehicular system according to <4> further includes:
an unsupported information transmitter unit (35) that, when the process-target is successfully specified by the process-target specifier unit but the process-command as the request is specified as not being supported in the process-target by the process-target specifier unit, transmits unsupported information to a vehicle-external device (35) indicating that the process-command is not supported in the process-target.

<6> The vehicular system according to <4> further includes:
a no-response information transmitter unit (36) that, when the process-target has successfully been specified by the process-target specifier unit but has not responded to the process-command as the request, transmits non-response information to a vehicle external device indicating no response to the process-command as the request.

<7> The vehicular system according to any one of <1> to <6> further includes:
an update request transmitter unit (37) that transmits an update request to a vehicle-external device to update the process-target specifier information.

<8> In the vehicular system according to <7>:
the update request transmitter unit transmits information enabling to specify the process-target specifier information retained in the vehicle-side specifier information retention unit to the vehicle-external device when transmitting the update request to the vehicle-external device.

<9> In the vehicular system according to <7> or <8>:
the update request transmitter unit transmits the update request to the vehicle-external device when the process-target is unsuccessfully specified by the process-target specifier unit.

<10> In the vehicular system according to <7> or <8>:
the update request transmitter unit periodically determines whether or not an update on the process-target specifier information is present in the vehicle-external device, and the update request transmitter unit transmits the update request to the vehicle-external device upon determining that the update on the process-target specifier information is present in the vehicle-external device.

<11> The vehicular system according to any one of <7> to <10>further includes:
a specifier information acquirer unit (38) that acquires the process-target specifier information from the vehicle-external device; and
a specifier information updater unit (39) that updates the process-target specifier information retained in the vehicle-side specifier information retention unit with the process-target specifier information acquired by the specifier information acquirer unit.

<12> The vehicular system according to any one of <1> to <11>further includes:
a format converter unit (19) that converts the message or the file in the SOVD format to a message or a file in a format not compliant with SOVD and corresponding to the process-target specified by the process-target specifier unit.

<13> A vehicle-external device (2) that delivers a message or a file in an SOVD format compliant with SOVD communication specifications to a vehicular system includes:
a vehicle-external side specifier information retention unit (41) that retains process-target specifier information indicating association between a process-command based on the message or the file in the SOVD format and connection destination information enabling to specify a process-target corresponding to the process-command; and
a specifier information delivery unit (42) that delivers the process-target specifier information retained in the vehicle-external side specifier information retention unit to the vehicular system.

<14> The vehicle-external device according to <13> further includes:
an update request receiver unit (43) that receives an update request transmitted from the vehicular system, wherein:
based on the update request received by the update request receiver unit, the specifier information delivery unit determines whether to deliver the process-target specifier information retained in the vehicle-external side specifier information retention unit to the vehicular system.

<15> In the vehicle-external device according to <14>:
the update request includes configuration information enabling to specify a vehicle configuration; and
based on the configuration information included in the update request, the specifier information delivery unit determines whether to deliver the process-target specifier information retained in the vehicle-external side specifier information retention unit to the vehicular system.

<16> The vehicle-external device according to any one of <13> to <15> further includes:
an update presence/absence checker unit (44) that determines whether an update on the process-target specifier information retained in the vehicle-external side specifier information retention unit is present or absent, wherein:
based on whether the update on the process-target specifier information retained in the vehicle-external side specifier information retention unit is present or absent, the specifier information delivery unit determines whether to deliver the process-target specifier information retained in the vehicle-external side specifier information retention unit to the vehicular system.

<17> The vehicle-external device according to any one of <13> to <16> further includes:
an undeliverable information transmitter unit (45) that, when the process-target specifier information is undeliverable to the vehicular system by the specifier information delivery unit, transmits undeliverable information to a related system indicating that the process-target specifier information is undeliverable to the vehicular system.

Although the present disclosure has been described in accordance with embodiments, it is to be understood that the present disclosure is not limited to the embodiments and structures. The present disclosure also encompasses various modifications and variations within equivalent ranges. Additionally, various combinations and configurations, as well as other combinations and configurations, including only a single element, more or less, are within the scope and spirit of the present disclosure.

Although the OTA center is shown as an example of a vehicle-external device to perform wireless reprograming and/or wireless diagnostic services, the vehicle-external device employed in a configuration may be, for example, a wired tool wired-connected to the CGW via an in-vehicle network and may be applicable to wired reprograming and wired diagnostic services.

The control units and methods described in the present disclosure may be implemented by a special purpose computer provided by configuring a processor and memory programmed to perform one or more functions embodied in a computer program. Alternatively, the control units and methods described in the present disclosure may be implemented by a special purpose computer provided by configuring a processor with one or more dedicated hardware logic circuits. Alternatively, the control units and methods described in the present disclosure may be implemented by one or more special purpose computers provided by configuring a processor and memory programmed to perform one or more functions in combination with a processor configured with one or more hardware logic circuits. The computer program may be stored in a computer-readable non-transitory tangible storage medium as instructions to be executed by a computer.

What is claimed is:

1. A vehicular system that acquires a message or a file in an SOVD format compliant with SOVD communication specifications, comprising
at least one computer, including: at least one memory and at least one processor configured to execute a program; and/or at least one hardware logic circuit, that implements:
a vehicle-side specifier information storage that retains process-target specifier information indicating association between a process-command based on the message or the file in the SOVD format and connection destination information enabling to specify a process-target corresponding to the process-command;
a process-command receiver that accepts the process-command; and
a process-target specifier that, when the process-command is accepted by the process-command receiver, refers to the process-target specifier information and specifies the process-target corresponding to the accepted process-command based on the connection destination information.

2. The vehicular system according to claim 1, wherein:
in addition to the connection destination information, the process-target specifier information further includes process method information enabling to specify a process method corresponding to the process-target; and
when the process-command is accepted by the process-command receiver, the process-target specifier refers to the process-target specifier information and specifies the process-target corresponding to the accepted process-command based on the connection destination information and further specifies the process method corresponding to the process-target based on the process method information.

3. The vehicular system according to claim 1, wherein
the at least one computer further implements:
a specifying-unsuccessful information transmitter that, when the process-target is unsuccessfully specified by the process-target specifier, transmits specifying-unsuccessful information to a vehicle-external device indicating that specifying the process-target is unsuccessful.

4. The vehicular system according to claim 1, wherein:
in addition to the connection destination information, the process-target specifier information further includes support information enabling to specify whether or not the process-command as a request is supported in the process-target; and
when the process-command is accepted by the process-command receiver, the process-target specifier refers to the process-target specifier information and specifies the process-target corresponding to the accepted process-command based on the connection destination information and further specifies based on the support information whether or not the process-command as the request is supported in the process-target.

5. The vehicular system according to claim 4, wherein
the at least one computer further implements:
an unsupported information transmitter that, when the process-target is successfully specified by the process-target specifier but the process-command as the request is specified as not being supported in the process-target by the process-target specifier, transmits unsupported information to a vehicle-external device indicating that the process-command is not supported in the process-target.

6. The vehicular system according to claim 4, wherein
the at least one computer further implements:
a no-response information transmitter that, when the process-target has successfully been specified by the process-target specifier but has not responded to the process-command as the request, transmits non-response information to a vehicle external device indicating no response to the process-command as the request.

7. The vehicular system according to claim 1, wherein
the at least one computer further implements:
an update request transmitter that transmits an update request to a vehicle-external device to update the process-target specifier information.

8. The vehicular system according to claim 7, wherein:
the update request transmitter transmits information enabling to specify the process-target specifier information retained in the vehicle-side specifier information storage to the vehicle-external device when transmitting the update request to the vehicle-external device.

9. The vehicular system according to claim 7, wherein:
the update request transmitter transmits the update request to the vehicle-external device when the process-target is unsuccessfully specified by the process-target specifier.

10. The vehicular system according to claim 7, wherein:
the update request transmitter periodically determines whether or not an update on the process-target specifier information is present in the vehicle-external device, and the update request transmitter transmits the update request to the vehicle-external device upon determining that the update on the process-target specifier information is present in the vehicle-external device.

11. The vehicular system according to claim 7, wherein
the at least one computer further implements:
a specifier information acquirer that acquires the process-target specifier information from the vehicle-external device; and
a specifier information updater that updates the process-target specifier information retained in the vehicle-side specifier information storage with the process-target specifier information acquired by the specifier information acquirer.

12. The vehicular system according to claim 1, wherein
the at least one computer further implements:
a format converter that converts the message or the file in the SOVD format to a message or a file in a format not compliant with SOVD and corresponding to the process-target specified by the process-target specifier.

13. A data communication system comprising:
a vehicle-external device that delivers a message or a file in an SOVD format compliant with SOVD communication specifications; and a vehicular system that receives the message or the file in the SOVD format delivered from the vehicle-external device,
wherein the vehicular system includes
at least one computer, including: at least one memory and at least one processor configured to execute a program; and/or at least one hardware logic circuit, that implements:
a vehicle-side specifier information storage that retains process-target specifier information indicating association between a process-command based on the message or the file in the SOVD format and connection destination information enabling to specify a process-target corresponding to the process-command;
a process-command receiver that accepts the process-command; and
a process-target specifier that, when the process-command is accepted by the process-command receiver, refers to the process-target specifier information and specifies the process-target corresponding to the accepted process-command based on the connection destination information.

14. A process-target specifying program stored in a non-transitory storage medium, the process-target specifying program causing a computer of a vehicular system, which vehicular system retains process-target specifier information indicating association between a process-command based on a message or a file in an SOVD format and connection destination information enabling to specify a process-target corresponding to the process-command, to perform:
accepting the process-command based on the message or the file in the SOVD format; and
referring to the process-target specifier information and specifying the process-target corresponding to the accepted process-command based on the connection destination information when the process-command is accepted.

15. A process-target specifying method in a vehicular system that retains process-target specifier information indicating association between a process-command based on a message or a file in an SOVD format and connection destination information enabling to specify a process-target corresponding to the process-command,
the process-target specifying method comprising:
accepting the process-command based on the message or the file in the SOVD format; and
referring to the process-target specifier information and specifying the process-target corresponding to the accepted process-command based on the connection destination information when the process-command is accepted.

16. A vehicle-external device that delivers a message or a file in an SOVD format compliant with SOVD communication specifications to a vehicular system, comprising
at least one computer, including: at least one memory and at least one processor configured to execute a program; and/or at least one hardware logic circuit, that implements:
a vehicle-external side specifier information storage that retains process-target specifier information indicating association between a process-command based on the message or the file in the SOVD format and connection destination information enabling to specify a process-target corresponding to the process-command; and
a specifier information deliverer that delivers the process-target specifier information retained in the vehicle-external side specifier information storage to the vehicular system.

17. The vehicle-external device according to claim 16, wherein
the at least one computer further implements:
an update request receiver that receives an update request transmitted from the vehicular system, wherein:
based on the update request received by the update request receiver, the specifier information deliverer determines whether to deliver the process-target specifier information retained in the vehicle-external side specifier information storage to the vehicular system.

18. The vehicle-external device according to claim 17, wherein:
the update request includes configuration information enabling to specify a vehicle configuration; and
based on the configuration information included in the update request, the specifier information deliverer determines whether to deliver the process-target specifier information retained in the vehicle-external side specifier information storage to the vehicular system.

19. The vehicle-external device according to claim 16, wherein
the at least one computer further implements:
an update presence/absence checker that determines whether an update on the process-target specifier information retained in the vehicle-external side specifier information storage is present or absent, wherein:
based on whether the update on the process-target specifier information retained in the vehicle-external side specifier information storage is present or absent, the specifier information deliverer determines whether to deliver the process-target specifier information retained in the vehicle-external side specifier information storage to the vehicular system.

20. The vehicle-external device according to claim 16, wherein
the at least one computer further implements:
an undeliverable information transmitter that, when the process-target specifier information is undeliverable to the vehicular system by the specifier information deliverer, transmits undeliverable information to a related system indicating that the process-target specifier information is undeliverable to the vehicular system.

21. A specifier information delivery program stored in a non-transitory storage medium, the specifier information delivery program causing a vehicle-external device, which vehicle-external device delivers a message or a file in an SOVD format compliant with SOVD communication specifications to a vehicular system and retains process-target specifier information indicating association between a process-command based on the message or the file in the SOVD format and connection destination information enabling to specify a process-target corresponding to the process-command, to perform:
delivering the process-target specifier information to the vehicular system.

22. A specifier information delivery method in a vehicle-external device that delivers a message or a file in an SOVD format compliant with SOVD communication specifications to a vehicular system and retains process-target specifier information indicating association between a process-command based on the message or the file in the SOVD format and connection destination information enabling to specify a process-target corresponding to the process-command, the specifier information delivery method comprising:
delivering the process-target specifier information to the vehicular system.

23. The vehicular system according to claim 2, wherein:
the at least one computer further implements:
sequence generator-executors that generate and execute a sequence, wherein
when the process-target specifier specifies that the process method is a collection method, the process-target specifier transmits the message or the file in the SOVD format or a generalized message converted from the SOVD message to the sequence generator-executor that corresponds to the process-target so that the sequence generator-executor generates and executes the sequence that corresponds to the process-target.

24. The vehicular system according to claim 23, wherein:
the sequence generator-executor generates and executes any of: the sequence according to a UCM format compliant with UCM communication specifications; the sequence according to an ODX/OTX format compliant with SOVD communication specifications; the sequence according to the ODX/OTX format compliant with ODX/OTX communication specifications; and the sequence according to the ODX/OTX format compliant with UDS communication specifications.

25. The vehicular system according to claim 23, wherein:
when the process-target specifier specifies a plurality of the process-targets, the process-target specifier generates, based on a default sequence, the sequence including an order in which processes on the plurality of the process-targets are performed.

26. The vehicular system according to claim 25, wherein:
from the default sequence, the process-target specifier removes the process on the process-target that corresponds to the message in the SOVD format or the generalized message and that is not supported in a host vehicle.

27. The vehicular system according to claim 23, wherein:
when the sequence generator-executor fails to generate the sequence, error information indicating a failure to generate the sequence along with a reason for the failure is caused to be transmitted to a transmission source of the message in the SOVD format or the generalized message by the sequence generator-executor.

28. The vehicular system according to claim 27, wherein:
the sequence generator-executor issues a request for software for generating the sequence to the transmission source of the message in the SOVD format or the generalized message.

29. The vehicular system according to claim 2, wherein:
when the process-target specifier specifies that the process method is a relay method, the process-target specifier transmits the message in the SOVD format or a generalized message converted from the SOVD message to the process-target.

30. The vehicular system according to claim 2, wherein:
the process-target specifier retains diagnostic information corresponding to the message in the SOVD format or a generalized message converted from the SOVD message when a retention method is specified as the process method.

31. The vehicular system according to claim 1, wherein:
the process-target specifier information is information indicating association between: the process-command based on the message or the file in the SOVD format;
the connection destination information enabling to specify the process-target corresponding to the process-command; service information indicating a message corresponding to the SOVD format; and support information enabling to specify whether the process-command as a request is supported in the process-target.

32. The vehicular system according to claim 1, wherein:
in addition to the connection destination information, the process-target specifier information further includes process method information enabling to specify a process method corresponding to the process-target from among a plurality of process methods; and
when the process-command is accepted by the process-command receiver, the process-target specifier refers to the process-target specifier information and specifies the process-target corresponding to the accepted process-command based on the connection destination information and further specifies the process method corresponding to the process-target based on the process method information.

33. The vehicular system according to claim 4, wherein:
the at least one computer further implements:
an unsupported information transmitter that, when the process-target is successfully specified by the process-target specifier but the process-command as the request is specified as not being supported in the process-target by the process-target specifier, transmits unsupported information to a source of the message or the file in the SOVD format, the unsupported information indicating that the process-command is not supported in the process-target.

34. The vehicular system according to claim 4, wherein:
the at least one computer further implements:
a no-response information transmitter that, when the process-target has successfully been specified by the process-target specifier and the process-command as the request has been specified as being supported in the process-target by the process-target specifier but the process-target has not responded to the process-command, transmits non-response information to a source of the message or the file in the SOVD format, the non-response information indicating no response to the process-command.
